(19) United States
(12) Patent Application Publication
(10) Pub. No.: US 2006/0041895 A1
(43) Pub. Date: Feb. 23, 2006

(54) Systems and methods for interfacing with codecs across an architecture optimized for audio

(75) Inventor: Frank Berreth, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 10/912,444

(22) Filed: Aug. 4, 2004

(51) Int. Cl. G06F 9/46

(52) U.S. Cl. 719/328

(57) ABSTRACT

Systems and methods for interfacing with codec(s) on an architecture optimized for audio are described. In one aspect, a device driver accesses an application programming interface (API). The API facilitates communications between the device driver and one or more codec(s) via a controller coupled to the codec(s). The codec(s) and the controller are implemented in an environment that is substantially optimized for audio. Such communication includes, for example, registering for event(s), transferring data to or from the codec(s), obtaining information about the capability of the codec(s), and/or managing bus or codec resources.

### TECHNICAL FIELD

The technical field pertains to interfacing with audio compressors/decompressors (codecs).

### BACKGROUND

Developing, testing, and supporting different audio codec chipset drivers can be time consuming and costly. In view of this, systems and techniques for standardization of interfaces that device drivers can use to interface with codecs coupled to controllers are desired.

### SUMMARY

Systems and methods for interfacing with codec(s) on an architecture optimized for audio are described. In one aspect, a device driver accesses an application programming interface (API). The API facilitates communications between the device driver and one or more codec(s) via a controller coupled to the codec(s). The codec(s) and the controller are implemented in an environment that is substantially optimized for audio. Such communication includes, for example, registering for event(s), transferring data to or from the codec(s), obtaining information about the capability of the codec(s), and/or managing bus or codec resources.

### BRIEF DESCRIPTION OF THE DRAWINGS

In the figures, the left-most digit of a component reference number identifies the particular figure in which the component first appears.

FIG. 1 shows exemplary architecture for device driver(s) to interface with codecs across a system that is substantially optimized for audio.

FIG. 2 shows an exemplary procedure to interface with codec(s) across an architecture substantially optimized for audio.

FIG. 3 shows an exemplary suitable computing environment on which the subsequently described systems, apparatuses and methods for interfacing with codecs across an architecture substantially optimized for audio may be fully or partially implemented.

### DETAILED DESCRIPTION

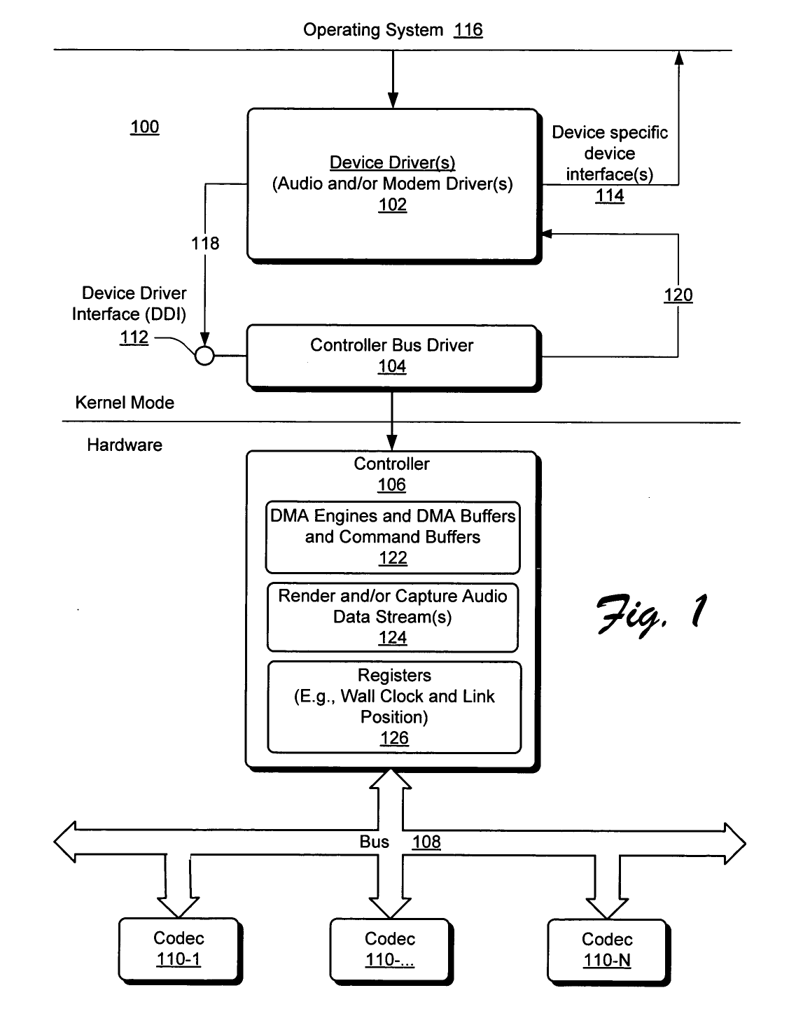

FIG. 1 shows exemplary architecture 100 for device driver(s) to interface with codec(s) across a system that is substantially optimized for audio. Architecture 100 is implemented in a computing device such as a general purpose computer. An environment that is substantially optimized for audio includes, for example, some combination of dynamic memory allocation (DMA) engine(s) that use cyclical buffers, synchronously stopping and starting multiple DMA engines at once, DMA engine with a constant bit rate, an ability to obtain a value from HW indicating a position of either the last data fetched/flushed by the DMA engine or the data currently transferred/received to/from the codec(s). Additionally, such an environment may include codecs with audio to digital converter(s) (ADC) and digital to audio converter(s) (DAC), as well as volume control, mixers, muxers, etc., and an interface to program ADCs and DACs. Exemplary environments optimized for audio are described in greater detail in: (1) “Intel® I/O Controller Hub 6 (ICH6) High Definition Audio/AC '97”, June 2004, which is hereby incorporated by reference in its entirety; and (2) “High Definition Audio Specification”, Revision 1.0, Apr. 15, 2004, which is also hereby incorporated by reference in its entirety.

Referring to FIG. 1, audio device driver architecture 100 includes device driver(s) 102, controller bus driver (“bus driver”) 104, and controller 106 coupled across bus 108 to one or more codec(s) 110-1 through 110-N. Codec(s) 110 may be audio or other types of codecs such as a modem codec. For purposes of discussion, system 100 is described in terms of use of audio codecs, although, as indicated other implementations may utilized one or more other types of codecs, and associated bus driver(s) 104, and/or audio controller(s) 106. In one implementation, a codec 110 is a High Definition (HD) audio codec. Bus 108 is a HD audio bus and controller 106 is a HD audio controller.

In this exemplary implementation, device driver(s) 102 query bus driver 104 for a device driver interface (DDI) 112 which provides the services needed for accessing the codec(s) 110. In a different implementation, DDI 112 and/or associated services/methods are provided independently of such a query, for example, via a static library. Device driver(s) 102 use DDI 112 to query codec(s) 110 for information associated with codec(s) 110. Such information is used by device driver 102 to generate device specific device interface(s) 114. Device specific device interface(s) 114 allow an operating system (OS) and/or applications operating under the OS to take advantage of a codec's capability for basic and advanced device functionality.

In this exemplary implementation, DDI 112 provides for:
transferring commands 118 to codec(s) 110;
receiving responses 120 to commands 118;
allocating and setting up dynamic memory allocation (DMA) engine(s) and buffers 122 with the controller 106 to transfer data for render and/or capture streams 124;
changing data stream state of one or more DMA engine(s) 122 to running, paused, stopped, or reset;
reserving audio link bandwidth on bus 108 for render and capture data streams 124;
directly accessing, by device driver(s) 102, wall clock and link position registers 126;
Notifying corresponding device driver(s) 102 of unsolicited response(s) 120 from codec(s) 110.

In this exemplary implementation, bus driver 104:
(a) queries codec(s) 110 and creates device objects (not shown) on which the system loads kernel mode device driver(s) 102 to interface and manage codec(s) 110;
(b) provides service for receipt of unsolicited responses 120 from codec(s) 110 and propagating such responses 120 to corresponding device driver(s) 102;
(c) provides device driver interface (DDI) 112 to pass commands 118 and responses 120 from/to device driver(s) 102 to/from codec(s) 110;
(d) sets-up dynamic memory access (DMA) engines, DMA buffers and command buffers 122 for transfer of data to/from cyclic buffers;
(e) manages bus 108 bandwidth resources on the audio link;
(f) provides access to wall clock and link position registers; and
(g) synchronizes starting and stopping of groups of data streams.
(h) provides version information about the HW and bus driver SW, controller capabilities and resource information for the device driver(s) 102
(i) provides wait wake capability which wakes up a sleeping system when an external event is registered from a codec 110
   An Exemplary High Definition (HD) Audio Device Driver Interface (DDI) 112

We now provide a more detailed exemplary implementation of the application programming interfaces (APIs) for DDI 112. In this implementation, there are two versions of DDI 112, as specified by the HDAUDIO_BUS_INTERFACE and HDAUDIO_BUS_INTERFACE_BDL structures. The HDAUDIO_BUS_INTERFACE structure specifies a baseline version of DDI 112. The HDAUDIO_BUS_INTERFACE_BDL structure specifies a modified version of DDI 112. This version accommodates the needs of a relatively few audio and modem drivers that require additional control over the setup of buffer descriptor lists (BDLs) for DMA operations. The particular component that implements the BDLs is up to the driver writer. In this implementation, audio device driver(s) 102 use the HDAUDIO_BUS_INTERFACE. In both of these structures, the names and types of the first five members match those of the five members of the INTERFACE structure. Controller bus driver 104 exposes one or both versions of DDI 112 to kernel-mode-device driver(s) 102.

In this implementation, the HDAUDIO_BUS_INTERFACE and HDAUDIO_BUS_INTERFACE_BDL versions of the DDI have the following differences:
The HDAUDIO_BUS_INTERFACE structure defines two routines, AllocateDmaBuffer and FreeDmaBuffer that are not present in HDAUDIO_BUS_INTERFACE_BDL.
The HDAUDIO_BUS_INTERFACE_BDL structure defines three routines, SetupDmaEngineWithBdl, AllocateContiguousDmaBuffer, and FreeContiguousDmaBuffer that are not present in HDAUDIO_BUS_INTERFACE.

To obtain access to either DDI version, a device driver 102 queries the controller bus driver 104 for a DDI context object. For more information, see the following: Obtaining an HDAUDIO_BUS_INTERFACE DDI Object and Obtaining an HDAUDIO_BUS_INTERFACE_BDL DDI Object. In this implementation, every routine in DDI 112 takes a pointer to the context object as its first call parameter.

When a device driver 102 calls the AllocateDmaBuffer routine in the HDAUDIO_BUS_INTERFACE, controller bus driver 104 does the following:
Allocates a DMA buffer and buffer descriptor list (BDL) for use by a DMA engine 122.
Initializes the BDL.
Sets up the DMA engine 122 to use the buffer and BDL.

In contrast, the AllocateContiguousDmaBuffer routine in HDAUDIO_BUS_INTERFACE_BDL allocates storage for a DMA buffer and BDL but relies on a respective device driver 102 to initialize the BDL. The SetupDmaEngineWithBdl routine sets up the DMA engine to use the buffer and the caller-initialized BDL. The BDL includes the list of physical memory blocks in the DMA engine's scatter-gather queue. By calling SetupDmaEngineWithBdl to set up the BDL, device driver 102 can specify the points in the data stream at which the DMA engine generates interrupts. Device driver 102 does this by setting the interrupt-on-completion (10C) bit in selected BDL entries. With this capability, device driver 102 can precisely control the timing of the IOC interrupts that occur during the processing of an audio stream 124.

However, many, if not substantially all device driver(s) 102 may use the HDAUDIO_BUS_INTERFACE version of DDI 112. For instance, in this implementation, only those device driver(s) 102 that desire precise control over the timing of interrupts use the HDAUDIO_BUS_INTERFACE_BDL version.

### Synchronous and Asynchronous Codec Commands

The TransferCodecVerbs routine allows device driver(s) 102 to send commands 118 to audio and modem codecs 110 that are connected to a controller 106. Commands 118 can execute either synchronously or asynchronously:
If a call to TransferCodecVerbs submits a list of commands 118 to be processed synchronously, the routine returns only after the codecs 110 have finished processing all commands 118.
If a call to TransferCodecVerbs submits a list of commands 118 to be processed asynchronously, the routine returns just as soon as the controller bus driver 104 adds commands 118 to its internal command queue, without waiting for codec(s) 110 to finish processing commands 118. After the codecs 110 have finished processing commands 118, the bus driver 104 notifies the device driver 102 by calling a callback routine that was passed in with the call to TransferCodecVerbs.

Depending on the nature of commands 118 that it sends, the device driver 102 uses one or more of the following techniques to retrieve responses 120 from codec(s) 110:
If the device driver 102 needs to have the response 120 from the codec 110 before the device driver 102 can perform any additional processing, it may use the synchronous mode.
If the device driver 102 has no need to wait for the codec 110 commands 118 to finish, no need to see the codec responses 120, and no need to know when commands 118 finish, then it may use the asynchronous mode, ignores the callback (except to free the storage for commands 118), and discards or ignores the responses 120 to commands 118.
If the device driver 102 needs to know when commands 118 finish, but it does not need to see the responses 120, then it may use the asynchronous mode and relies on the callback for notification. However, it discards or ignores the responses 120 to the codec commands. The callback routine might use a known kernel streaming (KS) event to forward the notification back to the main part of the driver.
If the device driver 102 needs to know both when the codec commands finish and what the responses 120 are, but it needs to resume processing immediately rather than waiting for the commands to finish, then it may use the asynchronous mode and avoids reading the responses 120 until it receives the callback. Either the callback routine or the main part of the driver can inspect the responses 120.

TransferCodecVerbs returns STATUS_SUCCESS if it succeeds in adding the list of commands 118 to the bus driver's internal command queue. Even if the call succeeds, though, the responses 120 might still be invalid. The device driver 102 checks the status bits in the codec responses 120 to determine whether they are valid. This technique applies to both synchronous and asynchronous mode.

The cause of an invalid response is likely one of the following: the command 118 did not reach the codec 110, or the audio codec did not respond (a bug in the codec), or the codec 110 responded but the response 120 was lost due to a FIFO overrun in the response input ring buffer (RIRB) DMA.

During a call to TransferCodecCommands, the caller provides a pointer to an array of HDAUDIO_CODEC_TRANSFER structures. Each structure includes a command 118 and provides space for a response 120. The bus driver 104 writes each response into the structure containing the command 118 that triggered the response 120.

For each call to TransferCodecCommands, the order in which commands 118 are processed is determined by the ordering of commands 118 in the array. Processing of the first command in the array completes before processing of the second command begins, and so on. If a client makes multiple asynchronous and/or synchronous calls to TransferCodecCommands then the group of commands is processed in the order received. This ordering is not maintained across multiple clients but only within the group of commands received from one client.

### Wall Clock and Link Position Registers

In this implementation, controller 106 includes a 32-bit wall clock counter register 126 that increments at the bit-clock rate of the audio link (bus 108) and rolls over approximately every 89 seconds. Software may use this counter to synchronize between two or more controller devices by measuring the relative drift between the devices' hardware clocks. Additionally, in this implementation, the controller 106 includes a set of link position registers 126. Each DMA engine 122 has a link position register that indicates the current read or write position of the data that the engine is transmitting over the audio link (bus 108). The position register 126 expresses the current position as a byte offset from the beginning of the DMA buffer 122:
In the case of a render stream 124, the link position register 126 indicates the cyclic DMA buffer offset of the next byte in the DMA buffer 122 that the DMA engine 122 will send over the link to the codec.
In the case of a capture stream 124, the link position register 126 indicates the cyclic DMA buffer offset of the next byte in the DMA buffer 122 that the DMA engine 122 will receive from the codec 110 over the link.

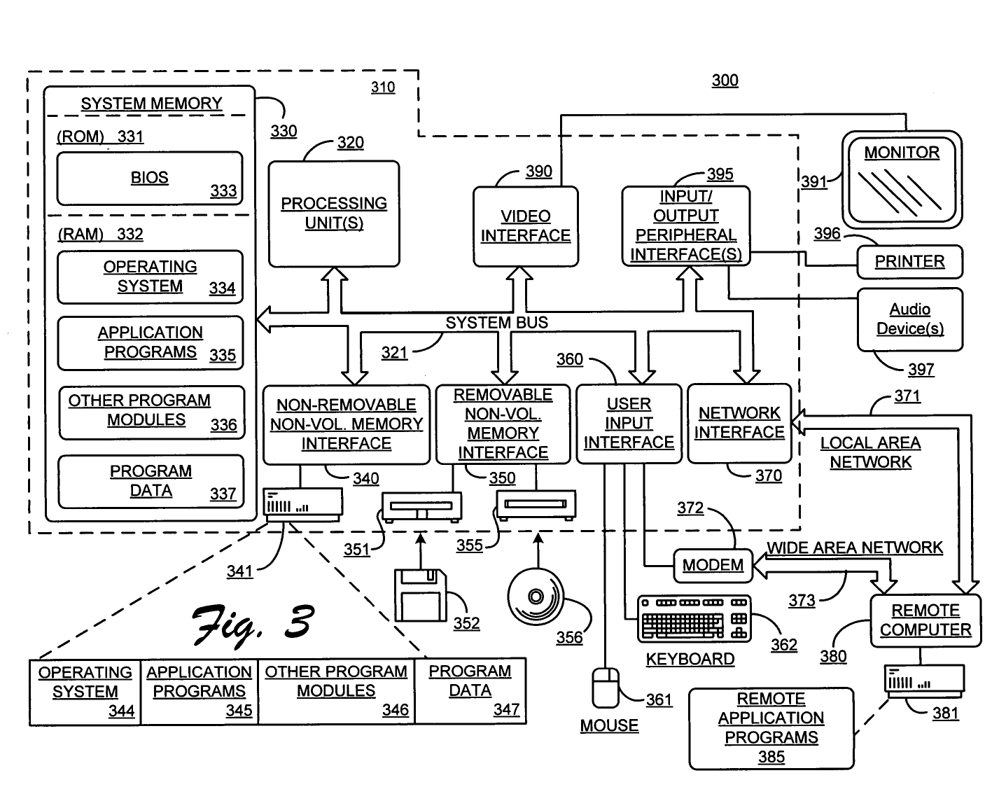

The cyclic buffer offset is simply the offset in bytes of the current read or write position from the start of the cyclic DMA buffer. Upon reaching the end of the buffer, the position wraps around to the start of the buffer and the cyclic DMA buffer offset resets to zero. The cyclic DMA buffer resides in system memory (e.g., see system memory 330 of FIG. 3).

A kernel-mode device driver 102 can read the wall clock and link position registers 126 directly. To enable direct access, controller bus driver 104 maps the physical memory containing the registers into system virtual kernel memory. The device driver 102 calls the GetWallClockRegister or GetLinkPositionRegister routine to obtain a system virtual kernel address pointer to the wall clock register or a link position register 126. These two routines are available in both versions of DDI 112.

Controller 106 hardware mirrors the wall clock and link position registers 126 into memory pages that do not contain any of the other registers in the controller. Thus, if the device driver 102 maps the mirrored wall clock or position registers to user mode, no user mode programs can access any of the controller's other registers. In this implementation, the driver does not allow a user-mode program to touch these other registers and program the hardware. Register mirroring accommodates the host processor's page size. Depending on the host processor architecture, a typical page size might be 4096 or 8192 bytes.

### Hardware Resource Management

Through DDI 112, device driver(s) 102 for modem and codecs 110 can allocate and free hardware resources in the controller 106 device. These resources are chiefly the following: DMA engines in the controller 106, and bus bandwidth on the audio link (bus 108)

### Allocating DMA Engines

The controller 106 includes a fixed number of DMA engines 122. Each engine can perform scatter-gather transfers for a single render or capture stream 124. In this implementation, there are three types of DMA engines available: Render DMA engines 122 handle render streams 124, Capture DMA engines 122 handle capture streams 124, and Bidirectional DMA engines 122 can be configured to handle either render or capture streams 124. When allocating a DMA engine 122 for a render stream, the AllocateCaptureDmaEngine routine allocates a render DMA engine 122 if one is available. If the supply of render DMA engines 122 is exhausted, the routine allocates a bidirectional DMA engine 122, if one is available. Similarly, when allocating a DMA engine for a capture stream, the AllocateRenderDmaEngine routine allocates a capture DMA engine if one is available. If the supply of capture DMA engines is exhausted, the routine allocates a bidirectional DMA engine if one is available. The AllocateXxxDmaEngine routines are available in both versions of DDI 112.

### Allocating Link Bandwidth

Audio link (bus 108) has a finite amount of bus bandwidth available for use by render and capture streams 124. To substantially ensure glitchless audio, the controller bus driver 104 manages bus bandwidth as a shared resource. When a device driver 102 allocates a DMA engine, it must also allocate a portion of the available bus bandwidth for use by the DMA engine's render or capture stream. A fixed amount of bus bandwidth is available on the audio link (bus 108)'s serial data in (SDI) lines, and a fixed amount of bus bandwidth is available on the serial data out (SDO) lines. The controller bus driver 104 keeps track of bandwidth consumption on the SDI and SDO lines separately. If a request to allocate input or output bus bandwidth exceeds the available bandwidth, the bus driver fails the request.

When the device driver 102 calls the bus driver's AllocateCaptureDmaEngine and AllocateRenderDmaEngine routine, it specifies a stream format. The stream format specifies the stream's sample rate, sample size, container size and number of channels. From this information, the AllocateXxxDmaEngine routine determines the stream's bus bandwidth requirements. If sufficient bandwidth is available, the routine allocates the required bandwidth for use by the DMA engine. Otherwise, the call to AllocateXxxDmaEngine fails.

A device driver 102 can call ChangeBandwidthAllocation to request a change in the bandwidth allocation for an existing DMA engine allocation.

The AllocateXxxDmaEngine and ChangeBandwidthAllocation routines are available in both versions of DDI 112.

### Striping

System architecture 100 of FIG. 1 supports a technique called striping that can increase the amount of bus bandwidth available for render streams 124. If the audio hardware interface provides more than one SDO line (Serial Data Out line), striping can increase the bandwidth available by alternately distributing the bits in the data stream among the SDO lines. The first bit (the most significant bit) travels over SDO0, the second bit travels over SDO1, and so on. For example, with two SDO lines, striping effectively doubles the bandwidth by splitting the stream between the two SDO lines. A DMA engine 122 that uses striping to transfer a render stream over two SDO lines consumes only half the bus bandwidth on the primary SDO line (SDO0) that it would consume if it did not use striping.

The device driver 102 enables striping through the AllocateRenderDmaEngine routine's stripe call parameter.

### Synchronizing Two or More Streams

The SetDmaEngineState routine sets the state of one or more DMA engines to one of the following: running, paused, stopped, or reset. If a call to this routine specifies more than one DMA engine, then all the DMA engines make the state transition synchronously.

The ability to synchronize a group of streams 124 is useful for some audio applications. For example, an audio driver might use codec-combining to create a logical surround-sound audio device that joins two codecs: one codec drives the front speakers and a second audio codec drives the back speakers. Depending on the capabilities of the codecs, the audio driver might need to split the original surround-sound audio stream into two streams 124, one for each codec. By using the SetDmaEngineState routine to start and stop the streams 124 in unison, the two streams 124 can remain synchronized.

Allowing the two streams 124 to fall out of synchronization by even a few samples might cause undesirable audio artifacts.

The SetDmaEngineState routine is available in both versions of DDI 112.

### Wake Enable

Before powering down a system comprising architecture 100 of FIG. 1, device driver 102 may enable a codec 110 to wake up the system if an external event occurs while the codec 110 is in the powered-down state. For an audio codec, such an event could be when the user inserts a plug into an input jack or removes a plug from a jack. For a modem codec, an external event could be when the phone rings to indicate an incoming call.

In preparation for powering down, the audio device driver 102 first configures the codec 110 to signal controller 106 through a status-change if an external event occurred. Next, the audio device driver 102 sends an IRP_MN_WAIT_WAKE power-management IRP to the controller bus driver 104 to tell it to enable the wake-up of the system through controller 106 if the codec issues a status-change request. Later, if the wake-up signal is enabled and the codec 110 transmits a status-change event over the codec's SDI line, the controller 106 generates a wake-up signal to the system and the bus driver 104 notifies the audio device driver 102 by completing the IRP_MN_WAIT_WAKE IRP. For information about IRP_MN_WAIT_WAKE, see the Windows DDK documentation.

Following a wake event, the bus driver 104 determines which codec 110 generated the wake-up signal and completes any IRP_MN_WAIT_WAKE IRPs that might be pending on that codec 110. However, if the codec 110 includes both audio and modem function groups, for example, the bus driver has no way to determine which function group is the source of the wake-up signal. In this case, the audio device driver 102 must send its own queries to the codec 110 to verify the source of the wake-up signal.

### Querying for a DDI

In this implementation, to obtain a counted reference to an object with an HD audio device driver interface (DDI), the audio device driver 102 for an audio or modem codec sends an IRP_MN_QUERY_INTERFACE IOCTL to the controller bus driver 104. TABLE 1 shows the input parameter values that the audio device driver 102 writes into the IRP_MN_QUERY_INTERFACE IOCTL to obtain an HDAUDIO_BUS_INTERFACE structure and a context object for the version of DDI 112 that this structure defines.

TABLE 1

| Parameter | Value |
|---|---|
| CONST GUID | GUID_HDAUDIO_BUS_INTERFACE |
| *InterfaceType | |
| USHORT Size | sizeof(HDAUDIO_BUS_INTERFACE) |
| USHORT Version | 0x0100 |
| PINTERFACE | Pointer to HDAUDIO_BUS_INTERFACE |
| Interface | structure |
| PVOID | NULL |
| InterfaceSpecificData | |

Device driver 102 allocates storage for the HDAUDIO_BUS_INTERFACE structure and includes a pointer to this structure in the IOCTL. In the preceding table, the pointer to the HDAUDIO_BUS_INTERFACE structure is cast to type PINTERFACE. PINTERFACE is a pointer to a structure of type INTERFACE. The names and types of the first five members of HDAUDIO_BUS_INTERFACE match those of the five members of INTERFACE. HDAUDIO_BUS_INTERFACE includes additional members that are function pointers to the DDI routines. In response to receiving the IOCTL from the audio device driver 102, the controller bus driver 104 fills in the entire HDAUDIO_BUS_INTERFACE structure.

Table 2 shows the values that the controller bus driver 104 writes into the first five members of the HDAUDIO_BUS_INTERFACE structure.

TABLE 2

| Parameter | Value |
|---|---|
| USHORT Size | sizeof |
| | (HDAUDIO_BUS_INTERFACE) |
| USHORT Version | 0x0100 |
| PVOID Context | Context information that needs to be |
| | passed as the first call parameter to |
| | every DDI routine |
| PINTERFACE_REFERENCE | Pointer to a routine that increments |
| InterfaceReference | the context object's reference count |
| PINTERFACE_DEREFERENCE | Pointer to a routine that decrements |
| InterfaceDereference | the context object's reference count |

As shown in TABLE 2, the Context member points to a context object that includes information that is specific to the particular instance of the baseline DDI 112 that device driver 102 obtains from the IOCTL. When calling any of the routines in the DDI, device driver 102 audio device driver 102 specifies the Context pointer value as the first call parameter. The context information is opaque to the client. The controller bus driver 104 creates a different context object for each client. When the context object is no longer needed, device driver 102 releases the context object by calling the InterfaceDereference routine shown in the preceding table. If needed, a client can create additional references to the object by calling the InterfaceReference routine, but device driver 102 is responsible for releasing these references when it no longer needs them.

### Obtaining an HDAUDIO_BUS_INTERFACE_BDL_DDI Object

As described above, audio device driver 102 for an audio or modem codec (not shown) obtains a counted reference to an object with an HD audio device driver interface (DDI) by sending an IRP_MN_QUERY_INTERFACE IOCTL to the controller bus driver 104. TABLE 3 shows the input parameter values that the audio device driver 102 writes into the IOCTL in order to obtain an HDAUDIO_BUS_INTERFACE_BDL structure and a context object for the version of DDI 112 that this structure defines.

TABLE 3

| Parameter | Value |
|---|---|
| CONST GUID | GUID_HDAUDIO_BUS_INTERFACE_BDL |
| *InterfaceType | |
| USHORT Size | Sizeof |
| | (HDAUDIO_BUS_INTERFACE_BDL) |
| USHORT Version | 0x0100 |
| PINTERFACE | Pointer to |
| Interface | HDAUDIO_BUS_INTERFACE_BDL |
| | structure |
| PVOID | NULL |
| InterfaceSpecificData | |

The audio device driver 102 allocates the storage for the HDAUDIO_BUS_INTERFACE_BDL structure and includes a pointer to this structure in the IOCTL. In the preceding table, the pointer to the HDAUDIO_BUS_INTERFACE_BDL structure is cast to type PINTERFACE. PINTERFACE is a pointer to a structure of type INTERFACE. The names and types of the first five members of HDAUDIO_BUS_INTERFACE_BDL match those of the five members of INTERFACE. HDAUDIO_BUS_INTERFACE_BDL includes additional members that are function pointers to the DDI routines. In response to receiving the IOCTL from the audio device driver 102, the controller bus driver 104 fills in the entire HDAUDIO_BUS_INTERFACE_BDL structure.

TABLE 4 shows the values that the controller bus driver 104 writes into the first five members of the HDAUDIO_BUS_INTERFACE_BDL structure.

TABLE 4

| Parameter | Value |
|---|---|
| USHORT Size | sizeof |
| | (HDAUDIO_BUS_{—} |
| | INTERFACE_BDL) |
| USHORT Version | 0x0100 |
| PVOID Context | Context information that needs to be |
| | passed as the first call parameter to |
| | every DDI routine |
| PINTERFACE_REFERENCE | Pointer to a routine that increments |
| InterfaceReference | the context object's reference count |
| PINTERFACE_DEREFERENCE | Pointer to a routine that decrements |
| InterfaceDereference | the context object's reference count |

In TABLE 4, the Context member points to a context object that includes information that is specific to the particular instance of the HDAUDIO_BUS_INTERFACE_BDL version of the DDI that device driver 102 obtains from the IOCTL. As explained previously, when calling any of the routines in the DDI, device driver 102 audio device driver 102 should always specify the Context pointer value as the first call parameter.

Appendix A, below, provides further detailed description of the APIs of DDI 112.

Exemplary Procedure for Interfacing with Codecs

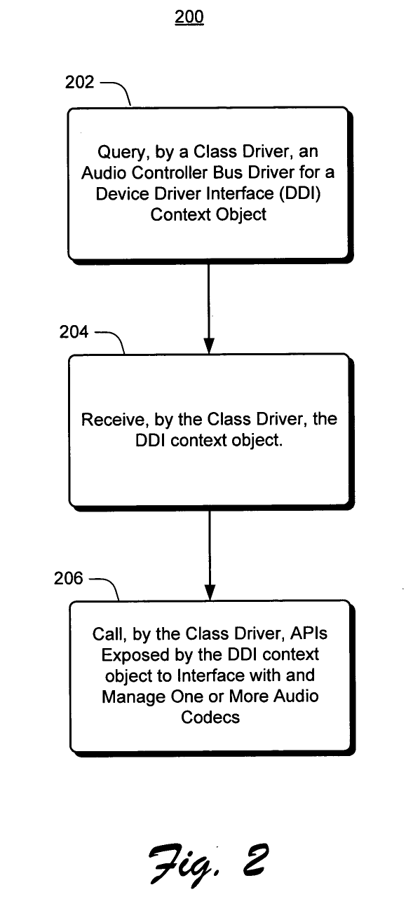

FIG. 2 shows an exemplary procedure 200 to interface with codec(s) across an architecture substantially optimized for audio. For purposes of discussion and illustration, the operations of procedure 200 are described in reference to aspects of FIG. 1. (The left-most digit of a component reference number identifies the particular figure in which the component first appears). At block 202, device driver 102 queries a controller bus driver 104 for a device driver interface (DDI) context object 112. Responsive to querying the controller bus driver 104, at block 204, the device driver 102 receives the DDI context object 112. At block 206, the device driver 102 calls, or invokes one or more application programming interfaces (APIs) exposed by the DDI context object 112 to interface with a codec 110-1 through 110-N.

Device driver 102 operations to interface with a codec 110 includes, for example, registering for event(s), transferring data (e.g., commands or data packets) to or from the codec(s); obtaining information about the codec(s), and/or managing bus or codec resource(s). Transferring data may include specifying a stream data format. Obtaining information about the codec(s) may include retrieving information about a controller, a link position register, a wall clock register, a codec, and/or a function group start node. Operations to manage bus or codec resources may include changing bandwidth allocation on the bus, managing a dynamic memory access (DMA) engine, managing a DMA buffer; managing audio link bandwidth allocation, setting a DMA engine state to running, stopped, paused, or reset, freeing a DMA engine, allocating a DMA buffer, and/or freeing a DMA buffer.

In this implementation, one driver 102 manages one codec 110. But for each function group in a codec 110 the bus driver 104 creates a device object (not shown) so that a device driver 102 can be loaded on it.

An Exemplary Operating Environment

FIG. 3 illustrates an example of a suitable computing environment 300 on which the system 100 of FIG. 1 and the procedure 200 of FIGS. 1 and 2 for interfacing with codecs across an architecture substantially optimized for audio may be fully or partially implemented. Accordingly, aspects of this computing environment 300 are described with reference to exemplary components and operations of FIGS. 1 and 2. The left-most digit of a component or operation (procedural block) reference number identifies the particular figure in which the component/operation first appears. Exemplary computing environment 300 is only one example of a suitable computing environment and is not intended to suggest any limitation as to the scope of use or functionality of systems and methods the described herein. Neither should computing environment 300 be interpreted as having any dependency or requirement relating to any one or combination of components illustrated in computing environment 300.

The methods and systems described herein are operational with numerous other general purpose or special purpose computing system environments or configurations. Examples of well-known computing systems, environments, and/or configurations that may be suitable for use include, but are not limited to, personal computers, server computers, multiprocessor systems, microprocessor-based systems, network PCs, minicomputers, mainframe computers, distributed computing environments that include any of the above systems or devices, and so on. Compact or subset versions of the framework may also be implemented in computing devices of limited resources, such as handheld computers, or other computing devices. The invention is practiced in a distributed computing environment where tasks are performed by remote processing devices that are linked through a communications network. In a distributed computing environment, program modules may be located in both local and remote memory storage devices.

With reference to FIG. 3, an exemplary system for interfacing with codecs across an architecture substantially optimized for audio includes a general purpose computing device in the form of a computer 310. Components of computer 310 may include, but are not limited to, processing unit(s) 320, a system memory 330, and a system bus 321 that couples various system components including the system memory to the processing unit 320. The system bus 321 connects controller 106 (FIG. 1) with the system and may be any of several types of bus structures including a memory bus or memory controller, a peripheral bus, and a local bus using any of a variety of bus architectures. By way of example and not limitation, such architectures may include Industry Standard architecture (ISA) bus, Micro Channel architecture (MCA) bus, Enhanced ISA (EISA) bus, Video Electronics Standards association (VESA) local bus, and Peripheral Component Interconnect (PCI) bus also known as Mezzanine bus or PCI Express bus.

A computer 310 typically includes a variety of computer-readable media. Computer-readable media can be any available media that can be accessed by computer 310 and includes both volatile and nonvolatile media, removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 310.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example and not limitation, communication media includes wired media such as a wired network or a direct-wired connection, and wireless media such as acoustic, RF, infrared and other wireless media. Combinations of the any of the above should also be included within the scope of computer-readable media.

System memory 330 includes computer storage media in the form of volatile and/or nonvolatile memory such as read only memory (ROM) 331 and random access memory (RAM) 332. A basic input/output system 333 (BIOS), containing the basic routines that help to transfer information between elements within computer 310, such as during start-up, is typically stored in ROM 331.

RAM 332 typically includes data and/or program modules that are immediately accessible to and/or presently being operated on by processing unit 320. By way of example and not limitation, FIG. 3 illustrates operating system 334, application programs 335, other program modules 336, and program data 338. In one implementation, operating system 334 comprises device driver(s) 102, controller bus driver 104, etc. Application programs 335 may include one or more computer-program applications that operate under operating system 334 that will use device specific device interface objects 114 of FIG. 1 to interface with device driver(s) 102, which in turn interface with one or more codecs connected to peripheral device such as audio devices 397 (e.g., speakers, microphones, headphones, and/or so on).

Program data 337 includes, for example, DDI context object(s) 112, device specific device interface(s) 114, parameters, and data (or commands) to transfer between device driver(s) 102 and codec(s) 110, intermediate calculations, other data, etc. In one implementation, program data 337 includes a static library through which a device driver 102 can access at least a portion of the functionality provided by DDI 112.

The computer 310 may also include other removable/non-removable, volatile/nonvolatile computer storage media. By way of example only, FIG. 3 illustrates a hard disk drive 341 that reads from or writes to non-removable, nonvolatile magnetic media, a magnetic disk drive 351 that reads from or writes to a removable, nonvolatile magnetic disk 352, and an optical disk drive 355 that reads from or writes to a removable, nonvolatile optical disk 356 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 341 is typically connected to the system bus 321 through a non-removable memory interface such as interface 340, and magnetic disk drive 351 and optical disk drive 355 are typically connected to the system bus 321 by a removable memory interface, such as interface 350.

The drives and their associated computer storage media discussed above and illustrated in FIG. 3, provide storage of computer-readable instructions, data structures, program modules and other data for the computer 310. In FIG. 3, for example, hard disk drive 341 is illustrated as storing operating system 344, application programs 345, other program modules 346, and program data 348. Note that these components can either be the same as or different from operating system 334, application programs 335, other program modules 336, and program data 338. Operating system 344, application programs 345, other program modules 346, and program data 348 are given different numbers here to illustrate that they are at least different copies.

A user may enter commands and information such as user audio policy data into the computer 310 through input devices such as a keyboard 362 and pointing device 361, commonly referred to as a mouse, trackball or touch pad. Other input devices (not shown) may include a microphone (audio capture) audio device, joystick, game pad, satellite dish, scanner, or the like. These and other input devices are often connected to the processing unit 320 through a user input interface 360 that is coupled to the system bus 321, but may be connected by other interface and bus structures, such as a parallel port, game port, a universal serial bus (USB), a wireless bus, IEEE 1394 AV/C bus, PCI bus, and/or the like.

A monitor 391 or other type of display device is also connected to the system bus 321 via an interface, such as a video interface 390. In addition to the monitor, computers may also include other peripheral output and/or input devices such as audio device(s) 397 and a printer 396, which may be connected through an output peripheral interface 395. In this implementation, respective ones of input and/or peripheral interface(s) 395 encapsulate operations of audio devices 397, which include codec(s) 110 of FIG. 1.

The computer 310 may operate in a networked environment using logical connections to one or more remote computers, such as a remote computer 380. The remote computer 380 may be a personal computer, a server, a router, a network PC, a peer device or other common network node, and as a function of its particular implementation, may include many or all of the elements described above relative to the computer 310, although only a memory storage device 381 has been illustrated in FIG. 3. The logical connections depicted in FIG. 3 include a local area network (LAN) 381 and a wide area network (WAN) 383, but may also include other networks. Such networking environments are commonplace in offices, enterprise-wide computer networks, intranets and the Internet.

When used in a LAN networking environment, the computer 310 is connected to the LAN 381 through a network interface or adapter 380. When used in a WAN networking environment, the computer 310 typically includes a modem 382 or other means for establishing communications over the WAN 383, such as the Internet. The modem 382, which may be internal or external, may be connected to the system bus 321 via the user input interface 360, or other appropriate mechanism. In a networked environment, program modules depicted relative to the computer 310, or portions thereof, may be stored in the remote memory storage device. By way of example and not limitation, FIG. 3 illustrates remote application programs 385 as residing on memory device 381. The network connections shown are exemplary and other means of establishing a communications link between the computers may be used.

### CONCLUSION

Although the systems and methods for interfacing with a codecs have been described in language specific to structural features and/or methodological operations or actions, it is understood that the implementations defined in the appended claims are not necessarily limited to the specific features or actions described. Accordingly, the specific features and actions are disclosed as exemplary forms of implementing the claimed subject matter.

### DDI Routines

The DDI 112 includes, for example, one or more of the following routines:
AllocateCaptureDmaEngine
AllocateContiguousDmaBuffer
AllocateDmaBuffer
AllocateRenderDmaEngine
ChangeBandwidthAllocation
FreeContiguousDmaBuffer
FreeDmaBuffer
FreeDmaEngine
GetDeviceInformation
GetLinkPositionRegister
GetResourceInformation
GetWallClockRegister
RegisterEventCallback
SetDmaEngineState
SetupDmaEngineWithBdl
TransferCodecVerbs
UnregisterEventCallback
   The preceding list includes exemplary routines that appear in either or both versions of the DDI 112. In another implementation, there may be more, fewer and/or different routines.
   AllocateCaptureDmaEngine

The AllocateCaptureDmaEngine routine allocates a DMA engine for a capture stream. The function pointer type for an AllocateCaptureDmaEngine routine is defined as follows:

```
typedef NTSTATUS
  (*PALLOCATE_CAPTURE_DMA_ENGINE)(
    IN PVOID context,
    IN UCHAR codecAddress,
    IN PHDAUDIO_STREAM_FORMAT streamFormat,
    OUT HANDLE *handle,
    OUT PHDAUDIO_CONVERTER_FORMAT converterFormat
    );
```

Parameters

context
Specifies the context value from the Context member of the HDAUDIO_BUS_INTERFACE or HDAUDIO_BUS_INTERFACE_BDL structure.

codecAddress
Specifies a codec address. This parameter identifies the serial data in (SDI) line on which the codec supplies the capture data to the HD Audio bus controller. A bus controller with n SDI pins can support up to n codecs with addresses ranging from 0 to n−1.

streamFormat
Specifies the requested stream format. This parameter points to a caller-allocated structure of type HDAUDIO_STREAM_FORMAT specifying a data format for the stream.

handle
Retrieves the handle to the DMA engine. This parameter points to a caller-allocated HANDLE variable into which the routine writes a handle identifying the DMA engine.

converterFormat
Retrieves the converter format. This parameter points to a caller-allocated structure of type HDAUDIO_CONVERTER_FORMAT into which the routine writes the encoded format.
   Return Value

AllocateCaptureDmaEngine returns STATUS_SUCCESS if the call succeeds in reserving a DMA engine. Otherwise, the routine returns an appropriate error code. The following table shows some of the possible return status codes.

| Error Code | Description |
|---|---|
| STATUS_INSUFFICIENT_RESOURCES | Indicates that either no |
| | DMA engine is available |
| | or the request exceeds |
| | the available bandwidth |
| | resources. |
| STATUS_INVALID_PARAMETER | Indicates that one of the |
| | parameter values is |
| | incorrect (invalid |
| | parameter value or bad |
| | pointer). |

Headers

Declared in hdaudio.h. Include hdaudio.h.

Comments

This routine allocates a capture DMA engine and specifies the data format for the stream. If successful, the routine outputs a handle that the caller subsequently uses to identify the DMA engine.

The AllocateCaptureDmaEngine routine reserves hardware resources (the DMA engine) but does not configure the DMA hardware. After calling this routine to reserve a DMA engine, a function driver needs to assign a DMA buffer to the DMA engine and configure the engine to use the buffer:
If using the HDAUDIO_BUS_INTERFACE version of the HD Audio DDI, the function driver calls the AllocateDmaBuffer routine to have the HD Audio bus driver allocate a data buffer for DMA transfers and set up the DMA engine to use the buffer.
If using the HDAUDIO_BUS_INTERFACE_BDL version of the DDI, the function driver calls AllocateContiguousDmaBuffer to allocate the DMA buffer and calls the SetupDmaEngineWithBdl routine to set up the DMA engine to use the buffer.

The streamFormat parameter specifies the data format for the capture stream. Following the call to AllocateCaptureDmaEngine, the stream's format can be changed by calling ChangeBandwidthAllocation.

Through the handle parameter, the routine outputs a handle that the caller uses to identify the allocated DMA engine in subsequent calls to AllocateDmaBuffer, ChangeBandwidthAllocation, FreeDmaBuffer, SetupDmaEngineWithBdl, and SetDmaEngineState. The function driver releases the handle by calling FreeDmaEngine.

Through the converterFormat parameter, the routine outputs a stream descriptor value that the caller can use to program the input converters. The routine encodes the information from the streamFormat parameter into a 16-bit integer. For more information, see HDAUDIO_CONVERTER_FORMAT.

Immediately following a successful call to AllocateCaptureDmaEngine, the DMA engine is in the reset stream state. Before calling SetDmaEngineState to change the DMA engine to the running, paused, or stopped state, the client must first allocate a DMA buffer for the engine.

A WDM audio driver calls AllocateCaptureDmaEngine at pin-creation time during execution of its NewStream method (for example, see the description of IMiniportWavePci::NewStream in the Windows DDK documentation).

Callers of AllocateCaptureDmaEngine must be running at IRQL PASSIVE_LEVEL.

See Also

HDAUDIO_BUS_INTERFACE, HDAUDIO_BUS_INTERFACE_BDL, HDAUDIO_STREAM_FORMAT, HDAUDIO_CONVERTER_FORMAT, AllocateDmaBuffer, AllocateContiguousDmaBuffer, SetupDmaEngineWithBdl, ChangeBandwidthReservation, SetDmaEngineState, FreeDmaEngine

AllocateContiguousDmaBuffer

The AllocateContiguousDmaBuffer routine allocates a DMA buffer consisting of a single, contiguous block of physical memory. The function pointer type for an AllocateContiguousDmaBuffer routine is defined as follows:

```
typedef NTSTATUS
  (*PALLOCATE_CONTIGUOUS_DMA_BUFFER)(
    IN PVOID context,
    IN HANDLE handle,
    ULONG requestedBufferSize,
    OUT PVOID *dataBuffer,
    OUT PHDAUDIO_BUFFER_DESCRIPTOR *bdl
    );
```

Parameters

context
Specifies the context value from the Context member of the HDAUDIO_BUS_INTERFACE_BDL structure.

handle
Handle identifying the DMA engine. This handle value was obtained from a previous call to AllocateCaptureDmaEngine or AllocateRenderDmaEngine.

requestedBufferSize
Specifies the requested buffer size in bytes.

dataBuffer
Retrieves the data buffer. This parameter points to a caller-allocated PVOID variable into which the routine writes the system virtual address of the data buffer.

bdl
Retrieves the BDL. This parameter points to a caller-allocated PVOID variable into which the routine writes the system virtual address of the BDL. The BDL allocation size is exactly one memory page and the BDL begins on a page boundary.
   Return Value

AllocateContiguousDmaBuffer returns STATUS_SUCCESS if the call succeeds. Otherwise, the routine returns an appropriate error code. The following table shows some of the possible return status codes.

| Error Code | Description |
|---|---|
| STATUS_UNSUCCESSFUL | Indicates that the caller is |
| | running at an IRQL that is too high. |
| STATUS_INSUFFICIENT_RESOURCES | Indicates that buffer allocation failed. |
| STATUS_INVALID_HANDLE | Indicates that the handle |
| | parameter value is invalid. |
| STATUS_INVALID_PARAMETER | Indicates that one of the |
| | parameter values is incorrect (bad pointer). |
| STATUS_DEVICE_NOT_READY | Indicates that the hardware |
| | programming timed out. If this |
| | occurs, the hardware might be in |
| | a compromised state. |
| STATUS_INVALID_DEVICE_REQUEST | Indicates that the stream is not |
| | in the reset state or that a buffer |
| | is already allocated for the DMA engine. |

Headers

Declared in hdaudio.h. Include hdaudio.h.

Comments

The AllocateContiguousDmaBuffer routine is used in conjunction with the SetupDmaEngineWithBdl and FreeContiguousDmaBuffer routines. These three routines are available only in the HDAUDIO_BUS_INTERFACE_BDL version of the HD Audio DDI. This DDI does not include the AllocateDmaBuffer and FreeDmaBuffer routines, which are never used in conjunction with AllocateContiguousDmaBuffer, SetupDmaEngineWithBdl, and FreeContiguousDmaBuffer. Unlike SetupDmaEngineWithBdl, which configures the DMA engine to use a previously allocated DMA buffer, AllocateDmaBuffer both allocates a DMA buffer and configures the DMA engine to use the buffer. For more information, see Differences between the Two DDI Versions.

AllocateContiguousDmaBuffer allocates a data buffer for the specified DMA engine. It also allocates a page of memory for the BDL. Depending on the host processor architecture, a typical page size might be 4096 or 8192 bytes. The data buffer consists of a single, contiguous block of physical memory.

The handle parameter specifies the DMA engine that is to use the data buffer and BDL. The routine allocates storage that meets the DMA engine's size, alignment, and position requirements.

The storage that the routine allocates for the data buffer and BDL is uninitialized. The function driver is responsible for filling in the BDL before submitting it to the SetupDmaEngineWithBdl routine. The function driver is also responsible for programming the codec to manage the data transfers and to recognize the stream identifier.

In order to generate IOC interrupts at precise intervals, the function driver might need to divide the data buffer allocation into several fragments of a particular size. Each fragment is described by a BDL entry. The fragment size can be adjusted to tune the interrupt rate. According to Intel's High Definition Audio specification, each fragment must begin on a 128-byte boundary, although no such alignment requirement applies to the length of the fragment. Thus, a gap might exist between the end of one fragment and the beginning of the next. When calling SetupDmaEngineWithBdl, the function driver should specify a value for the bufferSize parameter that represents the sum of the sizes of the individual fragments described by the BDL entries. This size will be less than or equal to the number of bytes specified in the AllocateContiguousDmaBuffer routine's requestedBufferSize parameter.

During the lifetime of a DMA engine handle, AllocateContiguousDmaBuffer can be called successively to allocate new DMA buffers. However, before calling AllocateContiguousDmaBuffer, any previously allocated DMA buffer must first be released by calling FreeContiguousDmaBuffer.

During calls to AllocateContiguousDmaBuffer, SetupDmaEngineWithBdl, and FreeContiguousDmaBuffer, the DMA engine must be in the reset stream state. The DMA engine is in the reset state immediately following the call to AllocateXxxDmaEngine. To change the DMA engine to the run state, call SetDmaEngineState.

This routine fails and returns error code STATUS_INVALID_DEVICE_REQUEST in either of the following circumstances:
Any previously allocated DMA buffer has not been freed (by calling FreeContiguousDmaBuffer).
The stream is in a state other than reset.

Callers of AllocateDmaBuffer must be running at IRQL PASSIVE_LEVEL.

See Also

HDAUDIO_BUS_INTERFACE_BDL, AllocateCaptureDmaEngine, AllocateRenderDmaEngine, SetupDmaEngineWithBdl, FreeContiguousDmaBuffer, AllocateDmaBuffer, FreeDmaBuffer SetDmaEngineState

AllocateDmaBuffer

The AllocateDmaBuffer routine allocates a data buffer in system memory for a DMA engine.

The function pointer type for an AllocateDmaBuffer routine is defined as follows:

```
typedef NTSTATUS
  (*PALLOCATE_DMA_BUFFER)(
    IN PVOID context,
    IN HANDLE handle,
    IN SIZE_T requestedBufferSize,
    OUT PMDL *bufferMdl,
    OUT SIZE_T *allocatedBufferSize,
    OUT UCHAR *streamID,
    OUT ULONG *fifoSize
    );
```

Parameters

context
Specifies the context value from the Context member of the HDAUDIO_BUS_INTERFACE structure.

handle
Handle identifying the DMA engine. This handle value was obtained from a previous call to AllocateCaptureDmaEngine or AllocateRenderDmaEngine.

requestedBufferSize
Specifies the requested buffer size in bytes.

bufferMdl
Retrieves the physical memory pages containing the allocated buffer. This parameter points to a caller-allocated PMDL variable into which the routine writes a pointer to a memory descriptor list (MDL) describing the buffer.

allocatedBufferSize
Retrieves the allocated buffer size in bytes. This parameter points to a caller-allocated SIZE_T variable into which the routine writes the size of the allocated buffer.

streamID
Retrieves the stream identifier. This parameter points to a caller-allocated UCHAR variable into which the routine writes the stream identifier that it assigns to the stream.

fifoSize
Retrieves the DMA engine's FIFO size in bytes. This parameter points to a caller-allocated ULONG variable into which the routine writes the FIFO size.
   Return Value

AllocateDmaBuffer returns STATUS_SUCCESS if the call succeeds. Otherwise, the routine returns an appropriate error code. The following table shows some of the possible return status codes.

| Error Code | Description |
|---|---|
| STATUS_UNSUCCESSFUL | Indicates that the caller is |
| | running at an IRQL that is too high. |
| STATUS_INSUFFICIENT_RESOURCES | Indicates that buffer allocation failed. |
| STATUS_INVALID_HANDLE | Indicates that the handle |
| | parameter value is invalid. |
| STATUS_INVALID_PARAMETER | Indicates that one of the |
| | parameter values is incorrect (bad pointer). |
| STATUS_DEVICE_NOT_READY | Indicates that the hardware |
| | programming timed out. If this |
| | occurs, the hardware might be in |
| | a compromised state. |
| STATUS_INVALID_DEVICE_REQUEST | Indicates that the stream is not |
| | in the reset state or that a buffer |
| | is already allocated for the DMA engine. |

Headers

Declared in hdaudio.h. Include hdaudio.h.

Comments

The AllocateDmaBuffer routine is used in conjunction with the FreeDmaBuffer routine. These two routines are available only in the HDAUDIO_BUS_INTERFACE version of the HD Audio DDI. This DDI does not include the AllocateContiguousDmaBuffer, SetupDmaEngineWithBdl, and FreeContiguousDmaBuffer routines, which are never used in conjunction with AllocateDmaBuffer and FreeDmaBuffer. Unlike SetupDmaEngineWithBdl, which configures the DMA engine to use a previously allocated DMA buffer, AllocateDmaBuffer both allocates a DMA buffer and configures the DMA engine to use the buffer.

If the DMA engine is unable to use a buffer of the size requested in parameter requestedBufferSize, the routine allocates a buffer that is as close as possible to the requested size.

The function driver for an audio or modem codec is responsible for programming the codec to manage the data transfers and to recognize the stream identifier.

The routine outputs an MDL that lists the physical memory pages containing the buffer. The buffer base address coincides with the start of the first physical page in the list.

During the lifetime of a DMA engine handle, AllocateDmaBuffer can be called successively to allocate new DMA buffers. However, before calling AllocateDmaBuffer, any previously allocated DMA buffer must first be released by calling FreeDmaBuffer.

During calls to AllocateDmaBuffer and FreeDmaBuffer, the DMA engine must be in the reset stream state. The DMA engine is in the reset state immediately following the call to AllocateXxxDmaEngine. To change the DMA engine to the run state, call SetDmaEngineState.

The FIFO size is the maximum number of bytes that the DMA engine can hold in its internal buffer. Depending on the hardware implementation, a DMA engine's FIFO size either can be static or can vary dynamically with changes in the stream format. For more information about the FIFO size, see Intel's High Definition Audio specification.

This routine fails and returns error code STATUS_INVALID_DEVICE_REQUEST in either of the following circumstances:
Any previously allocated DMA buffer has not been freed (by calling FreeDmaBuffer).
The stream is in a state other than reset.

In Windows Longhorn and later, a WaveRT miniport driver calls this routine when it receives the KSPROPERTY_RTAUDIO_BUFFER property request. In earlier operating systems, including Windows XP and Windows 2000, a WDM audio driver calls this routine during execution of its NewStream method (at pin-creation time) or SetFormat method (after calling one of the AllocateXxxDmaEngine routines in the HD Audio DDI). For more information, see the descriptions of the IMiniportWavePci::NewStream and IMiniportWavePciStream::SetFormat methods in the Windows DDK documentation.

Callers of AllocateDmaBuffer must be running at IRQL PASSIVE_LEVEL.

See Also

HDAUDIO_BUS_INTERFACE, SetupDmaEngineWithBdl, AllocateCaptureDmaEngine, AllocateRenderDmaEngine, FreeDmaBuffer, FreeDmaEngine, SetDmaEngineState

AllocateRenderDmaEngine

The AllocateRenderDmaEngine routine allocates a DMA engine for a render stream.

The function pointer type for an AllocateRenderDmaEngine routine is defined as follows:

```
typedef NTSTATUS
  (*PALLOCATE_RENDER_DMA_ENGINE)(
    IN PVOID context,
    IN PHDAUDIO_STREAM_FORMAT streamFormat,
    IN BOOLEAN stripe,
    OUT HANDLE *handle,
    OUT PHDAUDIO_CONVERTER_FORMAT converterFormat
    );
```

Parameters

context
Specifies the context value from the Context member of the HDAUDIO_BUS_INTERFACE or HDAUDIO_BUS_INTERFACE_BDL structure.

streamFormat
Specifies the requested stream format. This parameter points to a caller-allocated structure of type HDAUDIO_STREAM_FORMAT specifying a data format for the stream.

stripe
Specifies whether to enable striping. If TRUE, the routine enables striping in the DMA transfers. If FALSE, striping is disabled.

handle
Retrieves the handle to the DMA engine. This parameter points to a caller-allocated HANDLE variable into which the routine writes a handle identifying the DMA engine.

converterFormat
Retrieves the converter format. This parameter points to a caller-allocated structure of type HDAUDIO_CONVERTER_FORMAT into which the routine writes the encoded format.
   Return Value

AllocateRenderDmaEngine returns STATUS_SUCCESS if the call succeeds in reserving a DMA engine. Otherwise, the routine returns an appropriate error code. The following table shows some of the possible return status codes.

| Error Code | Description |
|---|---|
| STATUS_INSUFFICIENT_RESOURCES | Indicates that either no |
| | DMA engine is available |
| | or the request exceeds |
| | the available bandwidth |
| | resources. |
| STATUS_INVALID_PARAMETER | Indicates that one of the |
| | parameter values is |
| | incorrect (invalid |
| | parameter value |
| | or bad pointer). |

Headers

Declared in hdaudio.h. Include hdaudio.h.

Comments

This routine allocates a render DMA engine and specifies the data format for the stream. If successful, the routine outputs a handle that the caller subsequently uses to identify the DMA engine.

The AllocateRenderDmaEngine routine reserves hardware resources (the DMA engine) but does not configure the DMA hardware. After calling this routine to reserve a DMA engine, a function driver needs to assign a DMA buffer to the DMA engine and configure the engine to use the buffer:
If using the HDAUDIO_BUS_INTERFACE version of the HD Audio DDI, the function driver calls the AllocateDmaBuffer routine to have the HD Audio bus driver allocate a data buffer for DMA transfers and set up the DMA engine to use the buffer.
If using the HDAUDIO_BUS_INTERFACE_BDL version of the DDI, the function driver calls AllocateContiguousDmaBuffer to allocate the DMA buffer and calls the SetupDmaEngineWithBdl routine to set up the DMA engine to use the buffer.

The streamFormat parameter specifies the data format for the capture stream. Following the call to AllocateRenderDmaEngine, the stream's format can be changed by calling ChangeBandwidthAllocation.

The stripe parameter specifies whether the DMA engine is to use striping to speed up data transfers. For more information, see Striping.

Through the handle parameter, the routine outputs a handle that the caller uses to identify the allocated DMA engine in subsequent calls to AllocateDmaBuffer, ChangeBandwidthAllocation, FreeDmaBuffer, SetupDmaEngineWithBdl, and SetDmaEngineState. The function driver releases the handle by calling FreeDmaEngine.

Through the converterFormat parameter, the routine outputs a stream descriptor value that the caller can use to program the output converters. The routine encodes the information from the streamFormat parameter into a 16-bit integer. For more information, see HDAUDIO_CONVERTER_FORMAT.

Immediately following a successful call to AllocateRenderDmaEngine, the DMA engine is in the reset stream state. Before calling SetDmaEngineState to change the DMA engine to the running, paused, or stopped state, the client must first allocate a DMA buffer for the engine.

A WDM audio driver calls AllocateRenderDmaEngine at pin-creation time during execution of its NewStream method (for example, see the description of the IMiniportWavePci::NewStream method in the Windows DDK documentation).

Callers of AllocateRenderDmaEngine must be running at IRQL_PASSIVE_LEVEL.

See Also

HDAUDIO_BUS_INTERFACE, HDAUDIO_BUS_INTERFACE_BDL, HDAUDIO_STREAM_FORMAT, HDAUDIO_CONVERTER_FORMAT, AllocateDmaBuffer, ChangeBandwidthReservation, FreeDmaEngine

ChangeBandwidthAllocation

The ChangeBandwidthAllocation routine changes a DMA engine's bandwidth allocation on the HD Audio Link.

The function pointer type for a ChangeBandwidthAllocation routine is defined as follows:

```
typedef NTSTATUS
  (*PCHANGE_BANDWIDTH_ALLOCATION)(
    IN PVOID context,
    IN HANDLE handle,
    IN PHDAUDIO_STREAM_FORMAT streamFormat,
    OUT PHDAUDIO_CONVERTER_FORMAT converterFormat
    );
```

Parameters

context
Specifies the context value from the Context member of the HDAUDIO_BUS_INTERFACE or HDAUDIO_BUS_INTERFACE_BDL structure.

handle
Handle identifying the DMA engine. This handle value was obtained from a previous call to AllocateCaptureDmaEngine or AllocateRenderDmaEngine.

streamFormat
Specifies the requested stream format. This parameter points to a caller-allocated structure of type HDAUDIO_STREAM_FORMAT specifying a data format for the stream.

converterFormat
Retrieves the converter format. This parameter points to a caller-allocated structure of type HDAUDIO_CONVERTER_FORMAT into which the routine writes the encoded format. For more information, see the following Comments section.
   Return Value

ChangeBandwidthAllocation returns STATUS_SUCCESS if the call succeeds. Otherwise, the routine returns an appropriate error code. The following table shows some of the possible return status codes.

| Error Code | Description |
|---|---|
| STATUS_UNSUCCESSFUL | Indicates that the caller is |
| | running at an IRQL that is too high. |
| STATUS_INVALID_HANDLE | Indicates that the handle |
| | parameter value is invalid. |
| STATUS_INVALID_PARAMETER | Indicates that one of the |
| | parameter values is not correct |
| | (bad pointer or invalid stream format). |
| STATUS_INSUFFICIENT_RESOURCES | Indicates that insufficient |
| | bandwidth is available to satisfy the request |
| STATUS_INVALID_DEVICE_REQUEST | Indicates that the stream is not |
| | in the reset state or that a buffer |
| | is still allocated for the DMA engine. |

Headers

Declared in hdaudio.h. Include hdaudio.h.

Comments

The caller obtains an initial bandwidth allocation for a DMA engine by calling AllocateCaptureDmaEngine or AllocateRenderDmaEngine. Thereafter, the caller can change the bandwidth allocation by calling ChangeBandwidthAllocation.

Through the converterFormat parameter, the routine outputs a stream descriptor value that the caller can use to program the input or output converters. The routine encodes the information from the streamFormat parameter into a 16-bit integer. For more information, see HDAUDIO_CONVERTER_FORMAT.

This routine fails and returns error code STATUS_INVALID_DEVICE_REQUEST in either of the following circumstances:
Any previously allocated DMA buffer has not been freed (by calling FreeDmaBuffer or FreeContiguousDmaBuffer).
The stream is in a state other than reset.

If the ChangeBandwidthAllocation call fails, the existing bandwidth reservation remains in effect. The bandwidth allocation changes only if the call succeeds.

In Windows Longhorn and later, a wave miniport driver calls this routine during execution of its SetFormat method (after calling one of the AllocateXxxDmaEngine routines in the HD Audio DDI). For more information, see the descriptions of the IMiniportWavePciStream::SetFormat methods in the Windows DDK documentation.

Callers of ChangeBandwidthAllocation must be running at IRQL PASSIVE_LEVEL.

See Also

HDAUDIO_BUS_INTERFACE, HDAUDIO_BUS_INTERFACE_BDL, HDAUDIO_STREAM_FORMAT, HDAUDIO_CONVERTER_FORMAT, AllocateCaptureDmaEngine, AllocateRenderDmaEngine, FreeDmaBuffer, FreeContiguousDmaBuffer

FreeContiguousDmaBuffer

The FreeContiguousDmaBuffer routine frees a DMA buffer and BDL that were allocated by a call to AllocateContiguousDmaBuffer.

The function pointer type for a FreeContiguousDmaBuffer routine is defined as follows:

```
typedef NTSTATUS
  (*PFREE_CONTIGUOUS_DMA_BUFFER)(
    IN PVOID context,
    IN HANDLE handle
    );
```

Members

context
Specifies the context value from the Context member of the HDAUDIO_BUS_INTERFACE_BDL structure.

handle
Handle identifying the DMA engine. This handle value was obtained from a previous call to AllocateCaptureDmaEngine or AllocateRenderDmaEngine.
   Return Value

FreeContiguousDmaBuffer returns STATUS_SUCCESS if the call succeeds. Otherwise, the routine returns an appropriate error code. The following table shows some of the possible return status codes.

| Error Code | Description |
|---|---|
| STATUS_UNSUCCESSFUL | Indicates that the caller is |
| | running at an IRQL that |
| | is too high. |
| STATUS_INVALID_HANDLE | Indicates that the handle |
| | parameter value is |
| | invalid. |
| STATUS_INVALID_DEVICE_REQUEST | Indicates that the stream |
| | is not in the reset state or |
| | that no buffer is currently |
| | allocated for |
| | the DMA engine. |

Headers

Declared in hdaudio.h. Include hdaudio.h.

Comments

The FreeContiguousDmaBuffer routine is used in conjunction with the SetupDmaEngineWithBdl and AllocateContiguousDmaBuffer routines. These three routines are available only in the HDAUDIO_BUS_INTERFACE_BDL version of the HD Audio DDI. This DDI does not include the AllocateDmaBuffer and FreeDmaBuffer routines, which are never used in conjunction with AllocateContiguousDmaBuffer, SetupDmaEngineWithBdl, and FreeContiguousDmaBuffer. Unlike SetupDmaEngineWithBdl, which configures the DMA engine to use a previously allocated DMA buffer, AllocateDmaBuffer both allocates a DMA buffer and configures the DMA engine to use the buffer. For more information, see Differences between the Two DDI Versions.

The routine fails and returns error code STATUS_INVALID_DEVICE_REQUEST in either of the following circumstances:
The client calls FreeContiguousDmaBuffer when no buffer is currently allocated for the DMA engine.
The stream is in a state other than reset.

Callers of FreeContiguousDmaBuffer must be running at IRQL PASSIVE_LEVEL.

See Also

HDAUDIO_BUS_INTERFACE_BDL, AllocateCaptureDmaEngine, AllocateRenderDmaEngine, AllocateContiguousDmaBuffer, SetupDmaEngineWithBdl, AllocateDmaBuffer, FreeDmaBuffer

FreeDmaBuffer

The FreeDmaBuffer routine frees a DMA buffer that was previously allocated by a call to AllocateDmaBuffer.

The function pointer type for a FreeDmaBuffer routine is defined as follows:

```
typedef NTSTATUS
  (*PFREE_DMA_BUFFER)(
    IN PVOID context,
    IN HANDLE handle
    );
```

Parameters

context
Specifies the context value from the Context member of the HDAUDIO_BUS_INTERFACE structure.

handle
Handle identifying the DMA engine. This handle value was obtained from a previous call to AllocateCaptureDmaEngine or AllocateRenderDmaEngine.
   Return Value

FreeDmaBuffer returns STATUS_SUCCESS if the call succeeds. Otherwise, the routine returns an appropriate error code. The following table shows some of the possible return status codes.

| Error Code | Description |
|---|---|
| STATUS_UNSUCCESSFUL | Indicates that the caller is |
| | running at an IRQL |
| | that is too high. |
| STATUS_INVALID_HANDLE | Indicates that the handle |
| | parameter value |
| | is invalid. |
| STATUS_INVALID_DEVICE_REQUEST | Indicates that the |
| | stream is not in the |
| | reset state or that no |
| | buffer is currently |
| | allocated for |
| | the DMA engine. |

Headers

Declared in hdaudio.h. Include hdaudio.h.

Comments

The FreeDmaBuffer routine is used in conjunction with the AllocateDmaBuffer routine. These two routines are available only in the HDAUDIO_BUS_INTERFACE version of the HD Audio DDI. This DDI does not include the AllocateContiguousDmaBuffer, SetupDmaEngineWithBdl, and FreeContiguousDmaBuffer routines, which are never used in conjunction with AllocateDmaBuffer and FreeDmaBuffer. Unlike SetupDmaEngineWithBdl, which configures the DMA engine to use a previously allocated DMA buffer, AllocateDmaBuffer both allocates a DMA buffer and configures the DMA engine to use the buffer.

The routine fails and returns error code STATUS_INVALID_DEVICE_REQUEST in either of the following circumstances:
The client calls FreeDmaBuffer when no buffer is currently allocated for the DMA engine.
The stream is in a state other than reset.

Callers of FreeDmaBuffer must be running at IRQL PASSIVE_LEVEL.

See Also

AllocateDmaBuffer, HDAUDIO_BUS_INTERFACE, SetupDmaEngineWithBdl

FreeDmaEngine

The FreeDmaEngine routine frees a DMA engine that was previously allocated by a call to AllocateCaptureDmaEngine or AllocateRenderDmaEngine.

The function pointer type for a FreeDmaEngine routine is defined as follows:

```
typedef NTSTATUS
  (*PFREE_DMA_ENGINE)(
    IN PVOID context,
    IN HANDLE handle
    );
```

Parameters

context
Specifies the context value from the Context member of the HDAUDIO_BUS_INTERFACE or HDAUDIO_BUS_INTERFACE_BDL structure.

handle
Handle identifying the DMA engine. This handle value was obtained from a previous call to AllocateCaptureDmaEngine or AllocateRenderDmaEngine.
   Return Value

FreeDmaEngine returns STATUS_SUCCESS if the call succeeds in freeing the DMA engine. Otherwise, the routine returns an appropriate error code. The following table shows some of the possible return status codes.

| Error Code | Description |
|---|---|
| STATUS_INVALID_HANDLE | Indicates that the handle |
| | passed in is invalid. |
| STATUS_INVALID_DEVICE_REQUEST | Indicates that the stream |
| | is not in the reset state or |
| | that a buffer is still |
| | allocated for the DMA |
| | engine. |

Headers

Declared in hdaudio.h. Include hdaudio.h.

Comments

This routine frees a DMA engine that was previously reserved by a call to the AllocateCaptureDmaEngine or AllocateRenderDmaEngine routine.

This routine fails and returns error code STATUS_INVALID_DEVICE_REQUEST in either of the following circumstances:
Any previously allocated DMA buffer has not been freed (by calling FreeDmaBuffer or FreeContiguousDmaBuffer).

The stream is in a state other than reset.

An audio driver calls this routine to close the pin (and destroy the stream).

Callers of FreeDmaEngine must be running at IRQL<=DISPATCH_LEVEL.

See Also

HDAUDIO_BUS_INTERFACE, HDAUDIO_BUS_INTERFACE_BDL, AllocateCaptureDmaEngine, AllocateRenderDmaEngine, FreeDmaBuffer, FreeContiguousDmaBuffer

GetDeviceInformation

The GetDeviceInformation routine retrieves information about the HD Audio controller device.

The function pointer type for a GetDeviceInformation routine is defined as follows:

```
typedef NTSTATUS
  (*PGET_DEVICE_INFORMATION)(
    IN PVOID context,
    IN OUT PHDAUDIO_DEVICE_INFORMATION
    deviceInformation
    );
```

Parameters

context
Specifies the context value from the Context member of the HDAUDIO_BUS_INTERFACE structure.

deviceInformation
Retrieves information about the HD Audio controller device. This parameter points to a caller-allocated HDAUDIO_DEVICE_INFORMATION structure into which the routine writes the device information.
   Return Value

GetDeviceInformation returns STATUS_SUCCESS if the call succeeds. Otherwise, the routine returns an appropriate error code. The following table shows some of the possible return status codes.

| Error Code | Description |
|---|---|
| STATUS_BUFFER_TOO_SMALL | Indicates that the size specified at |
| | the beginning of the |
| | deviceInformation buffer is too |
| | small. |

Headers

Declared in hdaudio.h. Include hdaudio.h.

Comments

This routine retrieves device-dependent information that is static—that is, the information does not change dynamically over time.

The deviceInformation parameter is a pointer to a buffer containing an HDAUDIO_DEVICE_INFORMATION structure into which the routine writes information about the HD Audio controller. Before calling GetDeviceInformation, the caller allocates the buffer and writes the buffer's size in bytes into the Size member at the beginning of the buffer.

Callers of GetDeviceInformation must be running at IRQL PASSIVE_LEVEL.

See Also

HDAUDIO_BUS_INTERFACE, HDAUDIO_DEVICE_INFORMATION

GetLinkPositionRegister

The GetLinkPositionRegister routine retrieves a pointer to a DMA engine's link position register.

The function pointer type for a GetLinkPositionRegister routine is defined as follows:

```
typedef NTSTATUS
  (*PGET_LINK_POSITION_REGISTER)(
    IN PVOID context,
    IN HANDLE handle,
    OUT PULONG *position
    );
```

Parameters

context
Specifies the context value from the Context member of the HDAUDIO_BUS_INTERFACE or HDAUDIO_BUS_INTERFACE_BDL structure.

handle
Handle identifying the DMA engine. This handle value was obtained from a previous call to AllocateCaptureDmaEngine or AllocateRenderDmaEngine.

position
Retrieves a pointer to the link position register. This parameter points to a caller-allocated PULONG variable into which the routine writes a pointer to the register. The HD Audio bus driver maps the register to a system virtual address that is accessible to the function driver.
   Return Value

GetLinkPositionRegister returns STATUS_SUCCESS if the call succeeds. Otherwise, the routine returns an appropriate error code. The following table shows some of the possible return status codes.

| Error Code | Description |
|---|---|
| STATUS_INVALID_HANDLE | Indicates that the handle |
| | parameter value is invalid. |

Headers

Declared in hdaudio.h. Include hdaudio.h.

Comments

For more information, see Wall Clock and Link Position Registers.

Callers of GetLinkPositionRegister must be running at IRQL<=DISPATCH_LEVEL.

See Also

HDAUDIO_BUS_INTERFACE, HDAUDIO_BUS_INTERFACE_BDL, AllocateCaptureDmaEngine, AllocateRenderDmaEngine

GetResourceInformation

The GetResourceInformation routine retrieves information about hardware resources.

The function pointer type for a GetResourceInformation routine is defined as follows:

```
void
(*PGET_RESOURCE_INFORMATION)(
  IN PVOID context,
  OUT UCHAR *codecAddress,
  OUT UCHAR *functionGroupStartNode
);
```

Parameters

context
Specifies the context value from the Context member of the HDAUDIO_BUS_INTERFACE or HDAUDIO_BUS_INTERFACE_BDL structure.

codecAddress
Retrieves a codec address. This parameter points to a caller-allocated UCHAR variable into which the routine writes a codec address. The codec address identifies the serial data in (SDI) line on which the codec supplies response data to the HD Audio bus controller. A bus controller with n SDI pins can support up to n codecs with addresses ranging from 0 to n−1.

functionGroupStartNode
Retrieves the function group's starting node ID. This parameter points to a caller-allocated UCHAR variable into which the routine writes the node ID. For more information, see the following Comments section.
   Return Value

None

Headers

Declared in hdaudio.h. Include hdaudio.h.

Comments

A codec contains one or more function groups. Each function group contains some number of nodes that are numbered sequentially beginning with the starting node. For example, if a function group contains three nodes and the starting node has a node ID of 9, the other two nodes in the function group have node IDs 10 and 11. For more information, see Intel's High Definition Audio specification.

Callers of GetResourceInformation must be running at IRQL PASSIVE_LEVEL.

See Also

HDAUDIO_BUS_INTERFACE, HDAUDIO_BUS_INTERFACE_BDL

GetWallClockRegister

The GetWallClockRegister routine retrieves a pointer to the wall clock register.

The function pointer type for a GetWallClockRegister routine is defined as follows:

```
typedef void
(*PGET_WALL_CLOCK_REGISTER)(
  IN PVOID context,
  OUT PULONG *wallclock
  );
```

Parameters

context
Specifies the context value from the Context member of the HDAUDIO_BUS_INTERFACE or HDAUDIO_BUS_INTERFACE_BDL structure.

wallclock
Retrieves a pointer to the wall clock register. This parameter points to a caller-allocated PULONG variable into which the routine writes a pointer to the register. The HD Audio bus driver maps the register to a system virtual address that is accessible to the function driver.
   Return Value

None

Headers

Declared in hdaudio.h. Include hdaudio.h.

Comments

For more information, see Wall Clock and Link Position Registers.

Callers of GetWallClockRegister must be running at IRQL<=DISPATCH_LEVEL.

See Also

HDAUDIO_BUS_INTERFACE, HDAUDIO_BUS_INTERFACE_BDL

RegisterEventCallback

The RegisterEventCallback routine registers a callback routine for an unsolicited response from a codec or codecs.

The function pointer type for a RegisterEventCallback routine is defined as follows:

```
typedef NTSTATUS
(*PREGISTER_EVENT_CALLBACK)(
  IN PVOID context,
  IN PHDAUDIO_UNSOLICITED_RESPONSE_CALLBACK routine,
  IN PVOID callbackContext,
  OUT UCHAR *tag
  );
```

Parameters

context
Specifies the context value from the Context member of the HDAUDIO_BUS_INTERFACE or HDAUDIO_BUS_INTERFACE_BDL structure.

routine
Function pointer to a callback routine. This parameter must be a valid, non-NULL function pointer of type PHDAUDIO_UNSOLICITED_RESPONSE_CALLBACK. For more information, see the following Comments section.

callbackContext
Specifies a context value for the callback routine. The caller casts the context value to type PVOID. When a codec generates an unsolicited response containing the specified tag, the HD Audio bus driver passes the context value to the callback routine as a call parameter.

tag
Retrieves a tag value identifying the unsolicited response. This parameter points to a caller-allocated UCHAR variable into which the routine writes the tag value. The caller should specify this tag value when programming the codec or codecs to generate the unsolicited response. For more information, see the following Comments section.
   Return Value

RegisterEventCallback returns STATUS_SUCCESS if the call succeeds in registering the event. Otherwise, the routine returns an appropriate error code. The following table shows some of the possible return status codes.

| Error Code | Description |
|---|---|
| STATUS_INSUFFICIENT_RESOURCES | Indicates that not enough |
| | resources are available to |
| | complete the operation. |

Headers

Declared in hdaudio.h. Include hdaudio.h.

Comments

This routine registers a callback routine for an unsolicited response from a codec. The routine outputs a tag to identify the unsolicited response. When the HD Audio bus driver encounters an unsolicited response from any codec with a matching tag value, the routine calls the specified callback routine at IRQL DISPATCH_LEVEL, and it passes the specified context value to the routine as a call parameter.

Following the call to RegisterEventCallback, the function driver is responsible for programming the codec or codecs to generate unsolicited responses with the specified tag.

The routine assigns a unique tag to each registered callback routine. The unique association between tag and callback routine persists as long as the callback routine remains registered. The function driver can delete the registration of a callback routine by calling UnregisterEventCallback.

Currently, the bus driver can supply up to 64 unique tags. (In a future release, the plan is to increase the limit to 64 tags per codec.)

The callback parameter is a function pointer to a callback routine in the function driver. The function pointer type for the callback routine is defined as follows:

```
  typedef void
  (CALLBACK
*PHDAUDIO_UNSOLICITED_RESPONSE_CALLBACK)
    (HDAUDIO_CODEC_RESPONSE, PVOID);
```

The first call parameter is a structure of type HDAUDIO_CODEC_RESPONSE specifying the codec's response to the command. This structure is passed by value. The second call parameter is the callbackContext value that was earlier passed to RegisterEventCallback. The HD Audio bus driver calls the callback routine at IRQL DISPATCH_LEVEL.

Callers of RegisterEventCallback must be running at IRQL PASSIVE_LEVEL.

See Also

HDAUDIO_BUS_INTERFACE, HDAUDIO_BUS_INTERFACE_BDL, UnregisterEventCallback, HDAUDIO_CODEC_RESPONSE

SetDmaEngineState

The SetDmaEngineState routine sets the state of one or more DMA engines to the running, stopped, paused, or reset state.

The function pointer type for a SetDmaEngineState routine is defined as follows:

```
typedef NTSTATUS
(*PSET_DMA_ENGINE_STATE)(
  IN PVOID context,
  IN HDAUDIO_STREAM_STATE streamState,
  IN ULONG numberOfHandles,
  IN HANDLE *handles
  );
```

Parameters

context
Specifies the context value from the Context member of the HDAUDIO_BUS_INTERFACE or HDAUDIO_BUS_INTERFACE_BDL structure.

streamState
Specifies the new stream state. Set this parameter to one of the following HDAUDIO_STREAM_STATE enumeration values:
   PauseState (paused)
   ResetState (reset)
   RunState (running)
   StopState (stopped)
In the current implementation, PauseState and StopState represent the same hardware state.

numberOfHandles
Specifies the number of handles in the handles array. Set this parameter to a nonzero value.

handles
Pointer to an array of handles to DMA engines. Specify a non-NULL value for this parameter.
   Return Value

SetDmaEngineState returns STATUS_SUCCESS if the call succeeds in changing the DMA engines' states. Otherwise, the routine returns an appropriate error code. The following table shows some of the possible return status codes.

| Error Code | Description |
|---|---|
| STATUS_INVALID_HANDLE | Indicates that one of |
| | the handles is invalid. |
| STATUS_INVALID_PARAMETER | Indicates that one of the |
| | parameter values is |
| | incorrect (invalid |
| | parameter value or |
| | bad pointer). |
| STATUS_INVALID_DEVICE_REQUEST | Indicates that no buffer is |
| | currently allocated for |
| | one of the DMA engines. |

Headers

Declared in hdaudio.h. Include hdaudio.h.

Comments

This routine changes the state of one or more DMA engines to the state specified by the streamState parameter. The routine synchronizes the state transitions of all the DMA engines that are identified by the handles in the handles array. For more information, see Synchronizing Two or More Streams.

Before calling this routine, set up each DMA engine in the handles array:
If using the HDAUDIO_BUS_INTERFACE version of the HD Audio DDI, call AllocateDmaBuffer to set up the DMA engine.
If using the HDAUDIO_BUS_INTERFACE_BDL version of the DDI, call SetupDmaEngineWithBdl to set up the DMA engine.

If no DMA buffer is currently allocated for any DMA engine in the handles array, an attempt to change the stream to any state other than reset will cause the SetDmaEngineState call to fail and return error code STATUS_INVALID_DEVICE_REQUEST.

The stream state cannot transition directly between running and reset. Instead, the stream must first pass through an intermediate state of paused or stopped:
From a running or reset state, the stream state can change directly to either paused or stopped.
From a paused or stopped state, the stream state can change directly to either running or reset.

A WDM audio driver calls this routine during a call to its SetState method (for example, see the description of the IMiniportWaveRTStream::SetState method in the Windows DDK documentation).

Callers of SetDmaEngineState must be running at IRQL<=DISPATCH_LEVEL.

See Also

HDAUDIO_BUS_INTERFACE, HDAUDIO_BUS_INTERFACE_BDL, AllocateDmaBuffer, SetupDmaEngineWithBdl

SetupDmaEngineWithBdl

The SetupDmaEngineWithBdl routine sets up a DMA engine to use a caller-allocated DMA buffer.

The function pointer type for a SetupDmaEngineWithBdl routine is defined as follows:

```
typedef NTSTATUS
(*PSETUP_DMA_ENGINE_WITH_BDL)(
  IN PVOID context,
  IN HANDLE handle,
  IN ULONG bufferSize,
  IN ULONG lvi,
  IN PHDAUDIO_BDL_ISR isr,
  IN VOID *callbackContext,
  OUT UCHAR *streamID,
  OUT UINT *fifoSize
  );
```

Parameters

context
Specifies the context value from the Context member of the HDAUDIO_BUS_INTERFACE_BDL structure.

handle
Handle identifying the DMA engine. This handle value was obtained from a previous call to AllocateCaptureDmaEngine or AllocateRenderDmaEngine.

bufferSize
Specifies the size in bytes of the DMA buffer that is described by the bdl array.

lvi
Specifies the last valid index (LVI). This parameter contains the index for the last valid buffer descriptor in the buffer descriptor list (BDL). After the DMA engine has processed this descriptor, it will wrap back to the first descriptor in the list and continue processing. If the BDL contains n descriptors, they are numbered 0 to n−1. The lvi value must be at least 1; in other words, the BDL must contain at least two valid entries before the DMA engine can begin operation.

isr
Function pointer to the caller's interrupt service routine (ISR). If the caller sets the interrupt-on-completion (10C) bit in one or more of the buffer descriptors in the BDL, the HD Audio bus driver calls the ISR each time an IOC interrupt occurs on the stream. This parameter is a function pointer of type HDAUDIO_BDL_ISR, which is defined in the following Comments section.

callbackContext
Specifies a context value that the HD Audio bus driver passes to the ISR.

streamID
Retrieves the stream identifier. This parameter points to a caller-allocated UCHAR variable into which the routine writes the stream identifier that it assigns to the stream.

fifoSize
Retrieves the DMA engine's FIFO size in bytes. This parameter points to a caller-allocated UINT variable into which the routine writes the FIFO size.
   Return Value

SetupDmaEngineWithBdl returns STATUS_SUCCESS if the call succeeds. Otherwise, the routine returns an appropriate error code. The following table shows some of the possible return status codes.

| Error Code | Description |
|---|---|
| STATUS_UNSUCCESSFUL | Indicates that the caller is |
| | running at an IRQL that |
| | is too high. |
| STATUS_INVALID_HANDLE | Indicates that the handle |
| | parameter value is |
| | invalid. |
| STATUS_INVALID_PARAMETER | Indicates that one of the |
| | parameter values is |
| | incorrect (bad pointer |
| | or invalid stream |
| | format). |
| STATUS_DEVICE_NOT_READY | Indicates that the |
| | hardware programming |
| | timed out. If this occurs, |
| | the hardware might be in |
| | a compromised state. |
| STATUS_INVALID_DEVICE_REQUEST | Indicates that the DMA |
| | device or DMA buffer is |
| | not allocated or the |
| | stream is not in the reset |
| | state. |

Headers

Declared in hdaudio.h. Include hdaudio.h.

Comments

The SetupDmaEngineWithBdl routine is used in conjunction with the AllocateContiguousDmaBuffer and FreeContiguousDmaBuffer routines. These three routines are available only in the HDAUDIO_BUS_INTERFACE_BDL version of the HD Audio DDI. This DDI does not include the AllocateDmaBuffer and FreeDmaBuffer routines, which are never used in conjunction with AllocateContiguousDmaBuffer, SetupDmaEngineWithBdl, and FreeContiguousDmaBuffer. Unlike SetupDmaEngineWithBdl, which configures the DMA engine to use a previously allocated DMA buffer, AllocateDmaBuffer both allocates a DMA buffer and configures the DMA engine to use the buffer.

The caller must call AllocateContiguousDmaBuffer to allocate storage in the system memory for both the DMA buffer and the BDL that describes the physical memory pages in the buffer. The BDL entries must reside in memory that is physically contiguous. The BDL and buffer memory must meet the alignment requirements that are described in Intel's High Definition Audio specification.

Both the BDL and the buffer memory that it describes must remain valid during DMA operations. Following the call to SetupDmaEngineWithBdl, the BDL and buffer memory must remain valid as long as the DMA engine continues to use the buffer. The DMA engine uses the buffer until the function driver replaces the buffer by calling SetupDmaEngineWithBdl again or releases the DMA engine by calling FreeDmaEngine. The function driver is responsible for calling FreeContigousDmaBuffer to free the buffer and BDL when they are no longer needed.

When allocating memory for the buffer, the caller must satisfy all hardware constraints with regard to the address, length, and alignment of the physically contiguous blocks of memory that the BDL specifies. Thus, only clients with significant knowledge of the bus controller and system hardware should use the SetupDmaEngineWithBdl routine.

Before calling SetupDmaEngineWithBdl to configure a DMA engine, the client must call AllocateCaptureDmaEngine or AllocateRenderDmaEngine to allocate the DMA engine. The handle parameter is the value obtained from the preceding call to AllocateXxxDmaEngine.

The caller is responsible for programming the codec to manage the data transfers and to recognize the stream identifier.

A WDM audio driver calls this routine at pin-creation time during execution of its NewStream method (for example, see the description of the IMiniportWavePci::NewStream method in the Windows DDK documentation).

Following the call to SetupDmaEngineWithBdl, the DMA engine is in the reset state. To start the DMA engine, call SetDmaEngineState.

Parameter isr specifies the interrupt service routine that the HD Audio bus driver is to call each time an IOC interrupt occurs on the stream. This parameter is a function pointer of type HDAUDIO_BDL_ISR, which is defined as follows:

VOID (*PHDAUDIO_BDL_ISR)(IN VOID *context,
IN ULONG interruptBitMask);

The HD Audio bus driver calls the ISR with the same context value that the client specified in the context parameter of the preceding SetupDmaEngineWithBdl call. The interruptBitMask parameter contains the bits from the HD Audio controller device's stream status register that indicate the reason for the interrupt. The following table shows the meaning of the individual bits in interruptBitMask.

| Bit Numbers | Meaning |
|---|---|
| 31:5 | Unused. |
| 4 | Descriptor Error (DESE). If an error occurs during the |
| | fetch of a buffer descriptor, then the HD Audio |
| | controller sets the DESE bit to 1. |
| 3 | FIFO Error (FIFOE). If a FIFO error occurs (an |
| | overrun on an output stream or an underrun on an input |
| | stream), then the HD Audio controller sets the FIFOE |
| | bit to 1. |
| 2 | Buffer Completion Interrupt Status (BCIS). If the |
| | interrupt-on-completion (IOC) bit is set to 1 in the |
| | command byte of the buffer descriptor, then the |
| | HD Audio controller sets the BCIS bit to 1 after the last |
| | sample of a buffer has been processed. |
| 1:0 | Unused. |

The HD Audio bus driver sets the unused bits to zero. Instead of assuming that an IOC interrupt has occurred, the ISR should always check the interruptBitMask parameter to determine whether a stream error has occurred. For more information about the interrupt status bits shown in the preceding table, see the description of the stream status registers in Intel's High Definition Audio specification.

The FIFO size is the maximum number of bytes that the DMA engine can hold in its internal buffer at any one time. Depending on the hardware implementation, a DMA engine's FIFO size either can be static or can vary dynamically with changes in the stream format. For more information about the FIFO size, see Intel's High Definition Audio specification.

Callers of SetupDmaEngineWithBdl must be running at IRQL PASSIVE_LEVEL.

The caller must allocate the buffer memory and BDL from the nonpaged pool.

See Also

HDAUDIO_BUS_INTERFACE_BDL, HDAUDIO_BUFFER_DESCRIPTOR, AllocateDmaBuffer, FreeDmaBuffer, AllocateCaptureDmaEngine, AllocateRenderDmaEngine, SetDmaEngineState

TransferCodecVerbs

The TransferCodecVerbs routine transfers one or more commands to a codec or codecs and retrieves the responses to those commands.

The function pointer type for a TransferCodecVerbs routine is defined as follows:

```
typedef NTSTATUS
(*PTRANSFER_CODEC_VERBS)(
  IN PVOID context,
  IN ULONG count,
  IN OUT PHDAUDIO_CODEC_TRANSFER codecTransfer,
  IN PHDAUDIO_TRANSFER_COMPLETE_CALLBACK callback,
  IN PVOID callbackContext
  );
```

Parameters

context
Specifies the context value from the Context member of the HDAUDIO_BUS_INTERFACE or HDAUDIO_BUS_INTERFACE_BDL structure.

count
Specifies the number of elements in the codecTransfer array.

codecTransfer
Pointer to an array of HDAUDIO_CODEC_TRANSFER structures. Each array element is a structure containing storage for both an output command from the caller and the corresponding input response from the codec.

callback
Function pointer to a callback routine. This parameter is function pointer of type HDAUDIO_TRANSFER_COMPLETE_CALLBACK. The parameter can be specified as NULL. For more information, see the following Comments section.

callbackContext
A context value for the callback routine. The caller casts the context value to type PVOID. After completing the commands asynchronously, the HD Audio bus driver passes the context value to the callback routine as a call parameter.
   Return Value

TransferCodecVerbs returns STATUS_SUCCESS if the call succeeds. Otherwise, the routine returns an appropriate error code. The following table shows some of the possible return status codes.

| Error Code | Description |
|---|---|
| STATUS_NO_MEMORY | Indicates that the request could not |
| | be added to the command queue |
| | due to a shortage of nonpaged |
| | memory. |

Headers

Declared in hdaudio.h. Include hdaudio.h.

Comments

This routine submits one or more codec commands to the HD Audio bus driver. The bus driver issues the commands to the codecs, retrieves the codecs' responses to the commands, and outputs the responses to the caller.

The caller specifies the commands in an array of HDAUDIO_CODEC_TRANSFER structures. Each structure contains storage for both a command and the codec's response to that command. Before calling TransferCodecVerbs, the caller fills in the commands in each of the structures in the array. As each command completes, the HD Audio bus driver retrieves the codec's response and writes it into the structure. After the last command completes, the caller can read the responses from the array.

The routine can operate either synchronously or asynchronously: If the caller specifies NULL for the value of input parameter callback, the HD Audio bus driver completes the commands in the codecTransfer array synchronously. (In other words, the routine returns only after the codecs have finished processing all the commands and the responses to those commands are available.)

If the caller specifies a non-NULL value for the callback parameter, the routine operates asynchronously. (In other words, the routine returns immediately after adding the commands to its internal queue without waiting for the codecs to finish processing the commands.) After the codecs finish processing the commands, the HD Audio bus driver calls the callback routine. In the asynchronous case, the caller should not attempt to read the responses to the commands before the bus driver calls the callback routine.

The function pointer type for the callback parameter is defined as follows:

```
typedef void
  (*PHDAUDIO_TRANSFER_COMPLETE_CALLBACK)
    (HDAUDIO_CODEC_TRANSFER *, PVOID);
```

The first call parameter is a pointer to the codecTransfer array element containing the codec command and the response that triggered the callback. The second call parameter is the same context value that was specified previously in the TransferCodecVerbs routine's callbackContext parameter.

If successful, TransferCodecVerbs returns STATUS_SUCCESS. The meaning of this status code depends on whether the routine operates synchronously or asynchronously:

In the synchronous case (callback is NULL), STATUS_SUCCESS means that the bus driver has all the commands in the codecTransfer array to the codecs and that the routine has finished writing the responses to those commands into the array. However, the caller must check the individual responses to determine whether they are valid. Individual responses might be invalid due to codec timeouts or FIFO overrun.

In the asynchronous case (callback is non-NULL), STATUS_SUCCESS means only that the routine has successfully added the commands to the HD Audio bus driver's internal queue. The caller must not attempt to read the responses to those commands until the bus driver calls the callback routine.

If a response is invalid due to a FIFO overrun, the likely cause is that the codec responded to the command but the response was lost due to an insufficiently sized response input ring buffer (RIRB). If a FIFO overrun is not the cause of the invalid response, the failure probably occurred because the codec did not respond in time (timed out). In this case, the caller can assume that the command did not reach the codec.

If the callback parameter is NULL, the caller must be running at IRQL PASSIVE_LEVEL. If callback is non-NULL, the caller can call TransferCodecVerbs at IRQL<=DISPATCH_LEVEL, in which case the call returns immediately without waiting for the codecs to finish processing the commands; after the commands complete, the HD Audio bus driver calls the callback routine at IRQL DISPATCH_LEVEL.

The caller must allocate the codecTransfer array from the nonpaged pool.

See Also

HDAUDIO_BUS_INTERFACE, HDAUDIO_BUS_INTERFACE_BDL, HDAUDIO_CODEC_TRANSFER

UnregisterEventCallback

The UnregisterEventCallback routine deletes the registration of an event callback that was previously registered by a call to RegisterEventCallback.

The function pointer type for an UnregisterEventCallback routine is defined as follows:

```
typedef NTSTATUS
(*PUNREGISTER_EVENT_CALLBACK)(
  IN PVOID context,
  IN UCHAR tag
  );
```

Parameters

context
Specifies the context value from the Context member of the HDAUDIO_BUS_INTERFACE or HDAUDIO_BUS_INTERFACE_BDL structure.

tag
Specifies the tag value that was associated with the callback by the preceding call to RegisterEventCallback.
   Return Value

UnregisterEventCallback returns STATUS_SUCCESS if the call succeeds in changing the DMA engines' states. Otherwise, the routine returns an appropriate error code. The following table shows some of the possible return status codes.

| Error Code | Description |
|---|---|
| STATUS_INVALID_PARAMETER | Indicates that the specified tag is |
| | not valid. |

Headers

Declared in hdaudio.h. Include hdaudio.h.

Comments

Before calling this routine, the function driver is responsible for programming the codec or codecs to remove the association of the callback with the specified tag.

Callers of UnregisterEventCallback must be running at IRQL PASSIVE_LEVEL.

See Also

RegisterEventCallback, HDAUDIO_BUS_INTERFACE, HDAUDIO_BUS_INTERFACE_BDL

Structure Types

The routines in both versions of the HD Audio DDI use the following structure types:

HDAUDIO_BUFFER_DESCRIPTOR
HDAUDIO_BUS_INTERFACE
HDAUDIO_BUS_INTERFACE_BDL
HDAUDIO_CODEC_COMMAND
HDAUDIO_CODEC_RESPONSE
HDAUDIO_CODEC_TRANSFER
HDAUDIO_CONVERTER_FORMAT
HDAUDIO_DEVICE_INFORMATION
HDAUDIO_STREAM_FORMAT

HDAUDIO_BUFFER_DESCRIPTOR

The HDAUDIO_BUFFER_DESCRIPTOR structure specifies a buffer descriptor, which is an entry in a buffer descriptor list (BDL).

```
typedef struct _HDAUDIO_BUFFER_DESCRIPTOR
{
  PHYSICAL_ADDRESS Address;
  ULONG Length;
  ULONG InterruptOnCompletion;
} HDAUDIO_BUFFER_DESCRIPTOR,
*PHDAUDIO_BUFFER_DESCRIPTOR;
```

Members

Address
Specifies the start address of a physically contiguous fragment of the buffer. In the case of a 32-bit address, the address should be right-justified and the 32 MSBs of the member should be zero.

Length
Specifies the size in bytes of the buffer fragment.

InterruptOnCompletion
Specifies whether the DMA engine should generate an interrupt on completing the transfer of the buffer fragment. A value of 1 enables the interrupt. A value of 0 disables it.
   Headers

Declared in hdaudio.h. Include hdaudio.h.

Comments

A BDL is an array of HDAUDIO_BUFFER_DESCRIPTOR structures. Each structure specifies a physically contiguous fragment of the buffer. A BDL specifies all the fragments that make up the buffer.

The Address member contains the physical memory address of the start of the buffer fragment. The Length member specifies the number of bytes of physically contiguous memory that the fragment contains.

If the InterruptOnCompletion bit is set during a DMA transfer to or from the buffer fragment, the DMA engine generates an interrupt on completion of the transfer.

This structure is used by the AllocateContiguousDmaBuffer and SetupDmaEngineWithBdl routines.

For more information about BDLs, see Intel's High Definition Audio specification.

See Also

SetupDmaEngineWithBdl

HDAUDIO_BUS_INTERFACE

The HDAUDIO_BUS_INTERFACE structure specifies the information that a client needs to call the routines in the HDAUDIO_BUS_INTERFACE version of the HD Audio DDI. Another variant of this DDI is specified by the HDAUDIO_BUS_INTERFACE_BDL structure.

```
typedef struct _HDAUDIO_BUS_INTERFACE
{
  USHORT Size;
  USHORT Version;
  PVOID Context;
  PINTERFACE_REFERENCE InterfaceReference;
  PINTERFACE_DEREFERENCE InterfaceDereference;
  PTRANSFER_CODEC_VERBS TransferCodecVerbs;
  PALLOCATE_CAPTURE_DMA_ENGINE
AllocateCaptureDmaEngine;
  PALLOCATE_RENDER_DMA_ENGINE
  AllocateRenderDmaEngine;
  PCHANGE_BANDWIDTH_ALLOCATION
ChangeBandwidthAllocation;
  PALLOCATE_DMA_BUFFER AllocateDmaBuffer;
  PFREE_DMA_BUFFER FreeDmaBuffer;
  PFREE_DMA_ENGINE FreeDmaEngine;
  PSET_DMA_ENGINE_STATE SetDmaEngineState;
  PGET_WALL_CLOCK_REGISTER GetWallClockRegister;
  PGET_LINK_POSITION_REGISTER GetLinkPositionRegister;
  PREGISTER_EVENT_CALLBACK RegisterEventCallback;
  PUNREGISTER_EVENT_CALLBACK UnregisterEventCallback;
  PGET_DEVICE_INFORMATION GetDeviceInformation;
  PGET_RESOURCE_INFORMATION GetResourceInformation;
} HDAUDIO_BUS_INTERFACE, *PHDAUDIO_BUS_INTERFACE;
```

Members

Size
Specifies the size in bytes of the HDAUDIO_BUS_INTERFACE structure.

Version
Specifies the version of the baseline HD Audio DDI.

Context
Pointer to interface-specific context information.

InterfaceReference
Pointer to a driver-supplied routine that increments the interface's reference count.

InterfaceDereference
Pointer to a driver-supplied routine that decrements the interface's reference count.

TransferCodecVerbs
Function pointer to the TransferCodecVerbs routine.

AllocateCaptureDmaEngine
Function pointer to the AllocateCaptureDmaEngine routine.

AllocateRenderDmaEngine
Function pointer to the AllocateRenderDmaEngine routine.

ChangeBandwidthAllocation
Function pointer to the ChangeBandwidthAllocation routine.

AllocateDmaBuffer
Function pointer to the AllocateDmaBuffer routine.

FreeDmaBuffer
Function pointer to the FreeDmaBuffer routine.

FreeDmaEngine
Function pointer to the FreeDmaEngine routine.

SetDmaEngineState
Function pointer to the SetDmaEngineState routine.

GetWallClockRegister
Function pointer to the GetWallClockRegister routine.

GetLinkPositionRegister
Function pointer to the GetLinkPositionRegister routine.

RegisterEventCallback
Function pointer to the RegisterEventCallback routine.

UnregisterEventCallback
Function pointer to the UnregisterEventCallback routine.

GetDeviceInformation
Function pointer to the GetDeviceInformation routine.

GetResourceInformation
Function pointer to the GetResourceInformation routine.
   Headers

Declared in hdaudio.h. Include hdaudio.h.

Comments

The IRP_MN_QUERY_INTERFACE IOCTL uses this structure to provide interface information to a client that is querying the HD Audio bus driver for the HD Audio DDI. Another variant of this DDI is specified by the HDAUDIO_BUS_INTERFACE_BDL structure.

The HDAUDIO_BUS_INTERFACE and HDAUDIO_BUS_INTERFACE_BDL structures are similar but have the following differences:
HDAUDIO_BUS_INTERFACE has two members, AllocateDmaBuffer and FreeDmaBuffer, that are not present in HDAUDIO_BUS_INTERFACE_BDL.
HDAUDIO_BUS_INTERFACE_BDL has three members, AllocateContiguousDmaBuffer, FreeContiguousDmaBuffer, and SetupDmaEngineWithBdl, that are not present in HDAUDIO_BUS_INTERFACE.

For more information, see Differences between the Two DDI Versions.

The names and definitions of the first five members (Size, Version, Context, InterfaceReference, and InterfaceDereference) are the same as in the INTERFACE structure. The remaining members are specific to the baseline HD Audio DDI and specify function pointers to the routines in the DDI. For more information, see Obtaining an HDAUDIO_BUS_INTERFACE DDI Object.

See Also

TransferCodecVerbs, AllocateCaptureDmaEngine, AllocateRenderDmaEngine, ChangeBandwidthAllocation, AllocateDmaBuffer, FreeDmaBuffer. FreeDmaEngine, SetDmaEngineState, GetWallClockRegister, GetLinkPositionRegister, RegisterEventCallback, UnregisterEventCallback, GetDeviceInformation, GetResourceInformation, HDAUDIO_BUS_INTERFACE_BDL

HDAUDIO_BUS_INTERFACE_BDL

The HDAUDIO_BUS_INTERFACE_BDL structure specifies the information that a client needs to call the routines in the HDAUDIO_BUS_INTERFACE_BDL version of the HD Audio DDI. Another variant of this DDI is specified by the HDAUDIO_BUS_INTERFACE structure.

```
typedef struct _HDAUDIO_BUS_INTERFACE_BDL
{
  USHORT Size;
  USHORT Version;
  PVOID Context;
  PINTERFACE_REFERENCE InterfaceReference;
  PINTERFACE_DEREFERENCE InterfaceDereference;
  PTRANSFER_CODEC_VERBS TransferCodecVerbs;
  PALLOCATE_CAPTURE_DMA_ENGINE
AllocateCaptureDmaEngine;
  PALLOCATE_RENDER_DMA_ENGINE
  AllocateRenderDmaEngine;
  PCHANGE_BANDWIDTH_ALLOCATION
ChangeBandwidthAllocation;
  PALLOCATE_CONTIGUOUS_DMA_BUFFER
                  AllocateContiguousDmaBuffer;
  PSETUP_DMA_ENGINE_WITH_BDL SetupDmaEngineWithBdl;
  PFREE_CONTIGUOUS_DMA_BUFFER
  FreeContiguousDmaBuffer;
  PFREE_DMA_ENGINE FreeDmaEngine;
  PSET_DMA_ENGINE_STATE SetDmaEngineState;
  PGET_WALL_CLOCK_REGISTER GetWallClockRegister;
  PGET_LINK_POSITION_REGISTER GetLinkPositionRegister;
  PREGISTER_EVENT_CALLBACK RegisterEventCallback;
  PUNREGISTER_EVENT_CALLBACK UnregisterEventCallback;
  PGET_DEVICE_INFORMATION GetDeviceInformation;
  PGET_RESOURCE_INFORMATION GetResourceInformation;
} HDAUDIO_BUS_INTERFACE_BDL,
*PHDAUDIO_BUS_INTERFACE_BDL;
```

Members

Size
Specifies the size in bytes of the HDAUDIO_BUS_INTERFACE_BDL structure.

Version
Specifies the version of the extended HD Audio DDI.

Context
Pointer to interface-specific context information.

InterfaceReference
Pointer to a driver-supplied routine that increments the interface's reference count.

InterfaceDereference
Pointer to a driver-supplied routine that decrements the interface's reference count.

TransferCodecVerbs
Function pointer to the TransferCodecVerbs routine.

AllocateCaptureDmaEngine
Function pointer to the AllocateCaptureDmaEngine routine.

AllocateRenderDmaEngine
Function pointer to the AllocateRenderDmaEngine routine.

ChangeBandwidthAllocation
Function pointer to the ChangeBandwidthAllocation routine.

AllocateContiguousDmaBuffer
Function pointer to the AllocateContiguousDmaBuffer routine.

SetupDmaEngineWithBdl
Function pointer to the SetupDmaEngineWithBdl routine.

FreeContiguousDmaBuffer
Function pointer to the FreeContiguousDmaBuffer routine.

FreeDmaEngine
Function pointer to the FreeDmaEngine routine.

SetDmaEngineState
Function pointer to the SetDmaEngineState routine.

GetWallClockRegister
Function pointer to the GetWallClockRegister routine.

GetLinkPositionRegister
Function pointer to the GetLinkPositionRegister routine.

RegisterEventCallback
Function pointer to the RegisterEventCallback routine.

UnregisterEventCallback
Function pointer to the UnregisterEventCallback routine.

GetDeviceInformation
Function pointer to the GetDeviceInformation routine.

GetResourceInformation
Function pointer to the GetResourceInformation routine.
   Headers

Declared in hdaudio.h. Include hdaudio.h.

Comments

The IRP_MN QUERY_INTERFACE IOCTL uses this structure to provide interface information to a client that is querying the HD Audio bus driver for the HD Audio DDI. Another variant of this DDI is specified by the HDAUDIO_BUS_INTERFACE structure.

The HDAUDIO_BUS_INTERFACE_BDL and HDAUDIO_BUS_INTERFACE structures are similar but have the following differences:
HDAUDIO_BUS_INTERFACE_BDL has three members, AllocateContiguousDmaBuffer, SetupDmaEngineWithBdl, and FreeContiguousDmaBuffer, that are not present in HDAUDIO_BUS_INTERFACE.
HDAUDIO_BUS_INTERFACE has two members, AllocateDmaBuffer and FreeDmaBuffer, that are not present in HDAUDIO_BUS_INTERFACE_BDL.

For more information, see Differences between the Two DDI Versions.

The names and definitions of the first five members (Size, Version, Context, InterfaceReference, and InterfaceDereference) are the same as in the INTERFACE structure. The remaining members are specific to the extended HD Audio DDI and specify function pointers to the routines in the DDI. For more information, see Obtaining an HDAUDIO_BUS_INTERFACE DDI Object.

See Also

TransferCodecVerbs, AllocateCaptureDmaEngine, AllocateRenderDmaEngine, ChangeBandwidthAllocation, AllocateContiguousDmaBuffer, SetupDmaEngineWithBdl, FreeContiguousDmaBuffer, FreeDmaEngine, SetDmaEngineState, GetWallClockRegister, GetLinkPositionRegister, RegisterEventCallback, UnregisterEventCallback, GetResourceInformation, HDAUDIO_BUS_INTERFACE

HDAUDIO_CODEC_COMMAND

The HDAUDIO_CODEC_COMMAND structure specifies a codec command.

```
typedef struct _HDAUDIO_CODEC_COMMAND
{
  union
  {
    struct
    {
      ULONG Data : 8;
      ULONG VerbID : 12;
      ULONG Node : 8;
      ULONG CodecAddress : 4;
    } Verb8;
    struct
    {
      ULONG Data : 16;
      ULONG VerbID : 4;
      ULONG Node : 8;
      ULONG CodecAddress : 4;
    } Verb16;
    ULONG Command;
  };
} HDAUDIO_CODEC_COMMAND,
*PHDAUDIO_CODEC_COMMAND;
```

Members

Verb8.Data
Specifies an 8-bit data payload value for the 8-bit payload command format.

Verb8.VerbID
Specifies a 12-bit verb identifier for the 8-bit payload command format.

Verb8.Node
Specifies an 8-bit node identifier for the 8-bit payload command format.

Verb8.CodecAddress
Specifies a 4-bit codec address for the 8-bit payload command format.

Verb16.Data
Specifies an 16-bit data payload value for the 16-bit payload command format.

Verb16.VerbID
Specifies a 4-bit verb identifier for the 16-bit payload command format.

Verb16.Node
Specifies an 8-bit node identifier for the 16-bit payload command format.

Verb16.CodecAddress
Specifies a 4-bit codec address for the 16-bit payload command format.

Command
Specifies a 32-bit codec command containing payload data, a verb identifier, node identifier, and codec address.
   Headers

Declared in hdaudio.h. Include hdaudio.h.

Comments

Clients call the TransferCodecVerbs routine to pass commands to codecs. The commands are contained in the HDAUDIO_CODEC_TRANSFER structures that clients pass to this routine as call parameters. Before calling TransferCodecVerbs, function drivers can use the HDAUDIO_CODEC_COMMAND structure to encode the codec commands.

The validity of individual members depends on the type of command sent.

See Also

TransferCodecVerbs, HDAUDIO_CODEC_TRANSFER

HDAUDIO_CODEC_RESPONSE

The HDAUDIO_CODEC_RESPONSE structure specifies either a response to a codec command or an unsolicited response from a codec.

```
typedef struct _HDAUDIO_CODEC_RESPONSE
{
  union
  {
    struct
    {
      union
      {
        struct
        {
          ULONG Response : 26;
          ULONG Tag : 6;
        } Unsolicited;
        ULONG Response;
      };
      ULONG SDataIn : 4;
      ULONG IsUnsolicitedResponse : 1;
      ULONG :25;
      ULONG HasFifoOverrun : 1;
      ULONG IsValid : 1;
    };
    ULONGLONG CompleteResponse;
  };
} HDAUDIO_CODEC_RESPONSE,
*PHDAUDIO_CODEC_RESPONSE;
```

Members

Unsolicited.Response
Specifies a 26-bit unsolicited response value.

Unsolicited.Tag
Specifies a 6-bit tag value for an unsolicited response.

Unsolicited
Specifies a 32-bit unsolicited response value consisting of a 26-bit response value and a 6-bit tag value.

Response
Specifies a 32-bit solicited response value.

SDataIn
Specifies the 4-bit codec address (SDI line) of the codec generating the response.

IsUnsolicitedResponse
Specifies whether the response is unsolicited. If 1, the response is unsolicited. If 0, the response is solicited (that is, a response to a codec command).

HasFifoOverrun
Specifies whether a FIFO overrun occurred in the response input ring buffer (RIRB). If 1, a FIFO overrun occurred. If 0, a FIFO overrun did not occur.

IsValid
Specifies whether the response is valid. If 1, the response is valid. If 0, it is not valid.

CompleteResponse
Specifies a complete, 64-bit response summary consisting of a 32-bit response, 4-bit codec address, three status bits, and 25 unused bits (set to zero). This value is mostly used in debug messages.
   Headers

Declared in hdaudio.h. Include hdaudio.h.

Comments

After calling the TransferCodecVerbs routine, function drivers can use the HDAUDIO_CODEC_RESPONSE structure to decode the responses to their codec commands. The commands are contained in the HDAUDIO_CODEC_TRANSFER structures that clients pass to this routine as call parameters.

The callback for the RegisterEventCallback routine also uses the HDAUDIO_CODEC_RESPONSE structure.

Most members of this structure contain hardware-generated values that the bus driver copies directly from the corresponding response input ring buffer (RIRB) entry. The two exceptions are the values of the IsValid and HasFifoOverrun members, which the bus driver software writes to the structure to indicate the error status of the response. For information about the RIRB entry format, see Intel's High Definition Audio specification.

If IsValid=0, one of the following has occurred:
If HasFifoOverrun=1, the RIRB FIFO overflowed.
If HasFifoOverrun=0, the codec failed to respond.

The unnamed 25-bit field between the UnsolicitedResponse and HasFifoOverrun members is reserved for future expansion. The HD Audio bus controller currently writes zeros to this field.

See Also

TransferCodecVerbs, HDAUDIO_CODEC_TRANSFER, RegisterEventCallback

HDAUDIO_CODEC_TRANSFER

The HDAUDIO_CODEC_TRANSFER structure specifies a codec command and the response to that command.

```
typedef struct _HDAUDIO_CODEC_TRANSFER
{
  HDAUDIO_CODEC_COMMAND Output;
  HDAUDIO_CODEC_RESPONSE Input;
} HDAUDIO_CODEC_TRANSFER,
*PHDAUDIO_CODEC_TRANSFER;
```

Members

Output
Specifies a codec command for the HD Audio bus driver to output to a codec that is attached to the HD Audio controller. This member is a structure of type HDAUDIO_CODEC_COMMAND. Before calling the TransferCodecVerbs routine, the caller writes a codec command to this member.

Input
Specifies the response to the codec command. This member is a structure of type HDAUDIO_CODEC_RESPONSE. The HD Audio bus driver retrieves the response to the codec command contained in the Output member and writes the response into the Input member.
   Headers

Declared in hdaudio.h. Include hdaudio.h.

Comments

This structure is used by the TransferCodecVerbs routine:
At entry, the Output member contains a codec command from the caller.
At return, the Input member contains the response to the codec command.
   See Also

HDAUDIO_CODEC_COMMAND, HDAUDIO_CODEC_RESPONSE, TransferCodecVerbs

HDAUDIO_CONVERTER_FORMAT

The HDAUDIO_CONVERTER_FORMAT structure specifies the 16-bit encoded stream format for an input or output converter, as defined in Intel's High Definition Audio specification.

```
typedef struct _HDAUDIO_CONVERTER_FORMAT
{
  union
  {
    struct
    {
      USHORT NumberOfChannels : 4;
      USHORT BitsPerSample : 3;
      USHORT : 1;
      USHORT SampleRate : 7;
      USHORT StreamType: 1;
    };
    USHORT ConverterFormat;
  };
} HDAUDIO_CONVERTER_FORMAT,
*PHDAUDIO_CONVERTER_FORMAT;
```

Members

NumberOfChannels
Specifies the number of channels in the stream's data format. For more information, see the following Comments section.

BitsPerSample
Specifies the number of bits per sample. For more information, see the following Comments section.

SampleRate
Specifies the stream's sample rate. For more information, see the following Comments section.

StreamType
Specifies the stream type. If StreamType=0, the stream contains PCM data. If StreamType=1, the stream contains non-PCM data.

ConverterFormat

Specifies the stream's data format as an encoded 16-bit value. For more information, see the following Comments section.

Headers

Declared in hdaudio.h. Include hdaudio.h.

Comments

For information about the encoding of the individual bit fields in the structure definition, see the discussion of the stream descriptor in Intel's High Definition Audio specification.

The HD Audio bus driver sets the two unnamed bit fields in the structure definition to zero.

The AllocateCaptureDmaEngine, AllocateRenderDmaEngine, and ChangeBandwidthAllocation routines take as an input parameter an HDAUDIO_STREAM_FORMAT structure and output the corresponding HDAUDIO_CONVERTER_FORMAT structure. The caller can use the output value to program the input or output converters.

Each valid HDAUDIO_CONVERTER_FORMAT encoding has a one-to-one correspondence to an HDAUDIO_STREAM_FORMAT structure containing a valid set of parameters.

See Also

AllocateCaptureDmaEngine, AllocateRenderDmaEngine, ChangeBandwidthAllocation, HDAUDIO_STREAM_FORMAT

HDAUDIO_DEVICE_INFORMATION The HDAUDIO_DEVICE_INFORMATION structure specifies the hardware capabilities of the HD Audio bus controller.

```
typedef struct _HDAUDIO_DEVICE_INFORMATION
{
  USHORT Size;
  USHORT DeviceVersion;
  USHORT DriverVersion;
  USHORT CodecsDetected;
  BOOLEAN IsStripingSupported;
} HDAUDIO_DEVICE_INFORMATION,
*PHDAUDIO_DEVICE_INFORMATION;
```

Members

Size
Specifies the size in bytes of the HDAUDIO_DEVICE_INFORMATION structure.

DeviceVersion
Specifies the HD Audio controller device version.

DriverVersion
Specifies the HD Audio bus driver version.

CodecsDetected
Specifies the number of codecs that the HD Audio controller detects on the HD Audio Link.

IsStripingSupported
Specifies whether the HD Audio controller supports striping. If TRUE, it supports striping (with at least two SDO lines). If FALSE, it does not support striping.
   Headers

Declared in hdaudio.h. Include hdaudio.h.

Comments

The GetDeviceInformation routine uses this structure to provide information about the HD Audio controller's device-specific capabilities to clients.

See Also

GetDeviceInformation

HDAUDIO_STREAM_FORMAT

The HDAUDIO_STREAM_FORMAT structure describes the data format of a capture or render stream.

```
typedef struct _HDAUDIO_STREAM_FORMAT
{
  ULONG SampleRate;
  USHORT ValidBitsPerSample;
  USHORT ContainerSize;
  USHORT NumberOfChannels;
} HDAUDIO_STREAM_FORMAT,
*PHDAUDIO_STREAM_FORMAT;
```

Members

SampleRate
Specifies the sample rate in samples per second. This member indicates the rate at which each channel should be played or recorded.

ValidBitsPerSample
Specifies the number of valid bits per sample. The valid bits are left justified within the container. Any unused bits to the right of the valid bits must be set to zero.

ContainerSize
Specifies the size in bits of a sample container. Valid values for this member are 8, 16, 24, and 32.

NumberOfChannels
Specifies the number of channels of audio data. For monophonic audio, set this member to 1. For stereo, set this member to 2.
   Headers

Declared in hdaudio.h. Include hdaudio.h.

Comments

The AllocateCaptureDmaEngine, AllocateRenderDmaEngine, and ChangeBandwidthAllocation routines take as an input parameter an HDAUDIO_STREAM_FORMAT structure and output the corresponding HDAUDIO_CONVERTER_FORMAT structure. The information in a valid HDAUDIO_STREAM_FORMAT value can be encoded as an HDAUDIO_CONVERTER_FORMAT value.

This structure is similar to the WAVEFORMATEXTENSIBLE structure, but it omits certain parameters that are in WAVEFORMATEXTENSIBLE but are not relevant to the task of managing codecs that are connected to an HD Audio controller. For more information about WAVEFORMATEXTENSIBLE, see the Windows DDK documentation.

See Also

AllocateCaptureDmaEngine, AllocateRenderDmaEngine, ChangeBandwidthAllocation, HDAUDIO_CONVERTER_FORMAT

1. A method comprising:
accessing, by a device driver, an application programming interface (API), the API facilitating communications between the device driver and one or more codecs via a controller coupled to the codec(s), the codec(s) and the controller being in an environment that is substantially optimized for audio;
communicating, by a device driver, with the one or more codecs via respective ones of the APIs; and
wherein the communicating comprises:
registering for event(s)
transferring data to or from the codec(s);
obtaining information about the codec(s) or controller; or
managing bus or codec resource(s).

2. A method as recited in claim 1, wherein communicating further comprises a mechanism to wake-up a system when powered down

3. A method as recited in claim 1, wherein communicating further comprises forwarding data packet(s) to a codec of the one or more codecs for corresponding response by the codec.

4. A method as recited in claim 1, wherein communicating further comprises:
forwarding data packet(s) to a codec of the one or more codecs for corresponding response by the codec; and
if there are multiple data packets for communication to the codec, transferring respective ones of the multiple data packets synchronously or asynchronously.

5. A method as recited in claim 1, wherein transferring data further comprises specifying a stream data format.

6. A method as recited in claim 1, wherein obtaining information about the codec(s) or controller further comprises retrieving information about a controller, a link position register, a wall clock register, a codec, or a function group start node.

7. A method as recited in claim 1, wherein managing bus or codec resources further comprises changing bandwidth allocation on the bus.

8. A method as recited in claim 1, wherein managing further comprises:
managing a dynamic memory access (DMA) engine;
managing a DMA buffer; or
managing audio link bandwidth allocation.

9. A method as recited in claim 8, wherein the DMA engine is a render or capture engine.

10. A method as recited in claim 8, wherein the DMA engine is associated with a buffer descriptor list.

11. A method as recited in claim 8, wherein managing the DMA engine further comprises;
setting a DMA engine state to running, stopped, paused, or reset;
freeing a DMA engine;
allocating a DMA buffer; or
freeing a DMA buffer.

12. A method as recited in claim 11, wherein the DMA buffer is a contiguous DMA buffer.

13. A computer-readable memory comprising computer-program instructions execuatable by a processor, the computer-program instructions comprising:
an application programming interface (API), the API being directed to facilitating communications between a device driver and one or more codecs, the one or more codecs being coupled to a controller in an environment that is substantially optimized for audio; and
wherein the API comprises one or more respective interfaces for:
registering for event(s)
transferring data to or from the codec(s);
obtaining information about the codec(s); or
managing bus or codec resource(s).

14. A computer-readable medium as recited in claim 13, wherein an interface of the one or more respective interfaces for transferring data to or from the codec(s) futher comprises computer-program instructions for:
forwarding data packet(s) to a codec of the one or more codecs for corresponding response by the codec; and
if there are multiple data packets for communication to the codec, transferring respective ones of the multiple data packets synchronously or asynchronously

15. A computer-readable medium as recited in claim 13, wherein an interface of the one or more respective interfaces for transferring data to or from the codec(s) further comprises computer-program instructions for specifying a stream data format.

16. A computer-readable medium as recited in claim 13, wherein an interface of the one or more respective interfaces for obtaining information about the codec(s) further comprises computer-program instructions for retrieving information about a controller, a link position register, a wall clock register, a codec, or a function group start node.

17. A computer-readable medium as recited in claim 13, wherein an interface of the one or more respective interfaces for managing bus or codec resources further comprises computer-program instructions for changing bandwidth allocation on the bus.

18. A computer-readable medium as recited in claim 13, wherein an interface of the one or more respective interfaces for managing further comprises computer-program instructions for:
managing a dynamic memory access (DMA) engine;
managing a DMA buffer; or
managing audio link bandwidth allocation.

19. A computer-readable medium as recited in claim 14, wherein the DMA engine is a render or capture engine.

20. A computer-readable medium as recited in claim 14, wherein the DMA engine is associated with a buffer descriptor list.

21. A computer-readable medium as recited in claim 14, wherein managing the DMA engine further comprises;
setting a DMA engine state to running, stopped, paused, or reset;
freeing a DMA engine;
allocating a DMA buffer; or
freeing a DMA buffer.

22. A computer-readable medium as recited in claim 21, wherein the DMA buffer is a contiguous DMA buffer.

23. A computing device comprising:
a processor; and
a memory coupled to the processor, the memory comprising computer-program instructions executable by the processor for:
accessing, by a device driver, an application programming interface (API), the API facilitating communications between the device driver and one or more codecs via a controller coupled to the codec(s), the one or more codecs and the controller being implemented in an environment that is substantially optimized for audio;
communicating, by a device driver, with the one or more codecs via respective ones of the APIs; and
wherein the communicating comprises:
registering for event(s)
transferring data to or from the codec(s);
obtaining information about the codec(s); or
managing bus or codec resource(s).

24. A computing device as recited in claim 23, wherein the computer-program instructions for communicating further comprise instructions for forwarding data packet(s) to a codec of the one or more codecs for corresponding response by the codec.

25. A computing device as recited in claim 23, wherein the computer-program instructions for communicating further comprise instructions for:
forwarding data packet(s) to a codec of the one or more codecs for corresponding response by the codec; and
if there are multiple data packets for communication to the codec, transferring respective ones of the multiple data packets synchronously or asynchronously.

26. A computing device as recited in claim 23, wherein the computer-program instructions for transferring data further comprise instructions for specifying a stream data format.

27. A computing device as recited in claim 23, wherein the computer-program instructions for obtaining information about the codec(s) further comprise instructions for retrieving information about a controller, a link position register, a wall clock register, a codec, or a function group start node.

28. A computing device as recited in claim 23, wherein the computer-program instructions for managing bus or codec resources further comprise instructions for changing bandwidth allocation on the bus.

29. A computing device as recited in claim 23, wherein the computer-program instructions for managing further comprise instructions for:
managing a dynamic memory access (DMA) engine;
managing a DMA buffer; or
managing audio link bandwidth allocation.

30. A computing device as recited in claim 29, wherein the DMA engine is a render or capture engine.

31. A computing device as recited in claim 29, wherein the DMA engine is associated with a buffer descriptor list.

32. A computing device as recited in claim 29, wherein the computer-program instructions for managing the DMA engine further comprise instructions for;
setting a DMA engine state to running, stopped, paused, or reset;
freeing a DMA engine;
allocating a DMA buffer; or
freeing a DMA buffer.

33. A computing device as recited in claim 32, wherein the DMA buffer is a contiguous DMA buffer.

34. A computing device comprising:
accessing means to access, by a device driver, an application programming interface (API), the API facilitating communications between the device driver and one or more codecs via a controller operatively coupled to the codec(s), the codec(s) and the controller being implemented in an environment that is substantially optimized for audio;
communicating means to communicate, by a device driver, with the one or more codecs via respective ones of the APIs; and
wherein the communicating meanse comprise:
registering means to register for event(s)
transferring data means to transfer data to or from the codec(s);
obtaining means to obtain information about the codec(s); or
managing means to manage bus or codec resource(s).

35. A computing device as recited in claim 34, wherein the communicating means further comprise:
forwarding means to communicate data packet(s) to a codec of the one or more codecs for corresponding response by the codec; and
if there are multiple data packets for communication to the codec, transferring means to communicate respective ones of the multiple data packets synchronously or asynchronously.

36. A computing device as recited in claim 34, wherein the transferring means further comprise specifying means to set a particular stream data format.

37. A computing device as recited in claim 34, wherein the obtaining means further comprises retrieving means to gather information about a controller, a link position register, a wall clock register, a codec, or a function group start node.

38. A computing device as recited in claim 34, wherein the managing means further comprises changing means to change bandwidth allocation on the bus.

39. A computing device as recited in claim 34, wherein the managing means further comprises:
managing means to manage a dynamic memory access (DMA) engine;
managing means to manage a DMA buffer; or
managing means to manage audio link bandwidth allocation.

40. A computing device as recited in claim 39, wherein the managing means to manage the DMA engine further comprises;
setting means to set a DMA engine state to running, stopped, paused, or reset;
freeing means to free a DMA engine;
allocating means to allocate a DMA buffer; or
freeing means to free a DMA buffer.
